(19) United States
(12) Patent Application Publication
(10) Pub. No.: US 2025/0101248 A1
(43) Pub. Date: Mar. 27, 2025

(54) USE OF AQUEOUS POLYMER COMPOSITIONS AS STAINS FOR POROUS MATERIALS

(71) Applicant: BASF SE, Ludwigshafen am Rhein (DE)

(72) Inventors: Roelof BALK, Ludwigshafen am Rhein (DE); Bastiaan LOHMEIJER, Ludwigshafen am Rhein (DE); Oliver WAGNER, Ludwigshafen am Rhein (DE); Konrad ROSCHMANN, Ludwigshafen am Rhein (DE)

(21) Appl. No.: 18/698,054

(22) PCT Filed: Sep. 26, 2022
(86) PCT No.: PCT/EP2022/076667

§ 371 Date: Apr. 3, 2024

(30) Foreign Application Priority Data
Oct. 4, 2021 (EP) 21200699.3

(51) Int. Cl. C09D 15/00; C08F 8/28; C08F 220/18; C09D 5/02; C09D 133/06

(52) U.S. Cl. CPC C09D 15/00; C08F 8/28; C08F 220/1804; C09D 5/022; C09D 133/064; C08F 2810/20

(57) ABSTRACT

The present invention relates to use of an aqueous polymer composition containing a water-soluble or water-dispersible polymer P made of polymerized ethylenically unsaturated monomers M comprising.
30 to 90 wt.-%, based on the total weight of monomers M, of at least one monomer M1 selected from C₁-C₁₂-alkyl esters of monoethylenically unsaturated carboxylic acids, C₆-C₁₀-cycloalkyl esters of monoethylenically unsaturated carboxylic acids and monovinylaromatic hydrocarbon monomers,
5 to 30 wt.-%, based on the total weight of monomers M, of at least one monomer M2 selected from monoethylenically unsaturated monomers containing at least one acid group, and
5 to 40 wt.-%, based on the total weight of monomers M, of at least one monomer M3 different from M2 which has a reactive functional group being capable of being crosslinked,
wherein the total weight of monomers M1, M2 and M3 corresponds to at least 90% of the total weight of monomers M;
wherein the monomers M are selected such that the theoretical glass transition temperature according to Fox (Tg^{t}) of the polymer P is at most 80° C.; and
wherein the polymer P is dissolved or dispersed in an aqueous phase such that the acid groups of the polymer P are totally or partially neutralized; as a staining composition for porous materials.

The present invention also relates to an aqueous polymer composition containing said water-soluble or water-dispersible polymer P made of polymerized ethylenically unsaturated monomers M and a crosslinking agent.

The present invention relates to a use of an aqueous polymer composition containing a water-soluble or water-dispersible polymer P made of polymerized ethylenically unsaturated monomers M as a staining composition for porous materials.

The present invention also relates to an aqueous polymer composition containing a water-soluble or water-dispersible polymer P made of polymerized ethylenically unsaturated monomers M and a crosslinking agent.

### BACKGROUND ON THE INVENTION

Wood and wooden materials have been applied in various fields, for example in the manufacture of flooring, furniture, wood decks and tiles for countless generations. To protect the wooden surface against mechanical or chemical damages, wood coatings are essential to maintain esthetics for prolonged periods of time. When the wood is employed for exterior use, such as wood tiles, the surface of the wooden material is frequently exposed to strong mechanical and weathering stresses arising from changes in local temperature and moisture content. Therefore, there are stringent requirements to the protect the wood against such stresses. For this, wood coatings are applied to the wooden material in order to achieve protection in terms of hardness, scratch-, abrasion-, water- and UV-resistance.

For a large number of applications, a natural appearance of the wooden surface is required. For this, the coating must provide good film transparency, good accentuation of wood grains, good processing properties and low swelling of wood fibers upon exposure to humid conditions. In principle wood stains provide both a natural appearance of the wood and protection against mechanical and weathering stresses to a certain extent. Modern wood stains require to withstand a great deal of traffic, wear and mechanical and chemical damages to protect the wood beneath. It is particularly important for wood stains to impart excellent weather resistance and durability to the wood and wooden materials that are used for exterior uses. In order to improve the weather resistance, wood is conventionally treated with stains based on an oxidative drying oil such as linseed oil.

EP 267562 describes to a process for the preparation of water-dilutable air-drying paint binders based on vinyl-or acrylic-modified alkyd resin emulsions and their use in oxidatively air-drying at temperatures up to 100° C. and their use in water-dilutable coatings.

EP 0356920 describes water-dilutable, air-drying protective coating compositions based on a combination of select water-dilutable alkyd resins with aqueous polymer dispersions and maleinized oils or fatty acids. The products are used with or without pigments, extenders and/or paint adjuvants or additives, depending on the particular end-application, as air-drying protective coating compositions for wood and metal substrates, particularly for brushing lacquers and wood varnishes.

WO 92/14763 describes a process for producing an aqueous, autoxidatively drying emulsion polymer, preferably used as binder for lacquers. A carboxyl group-containing solution polymer is first produced by polymerizing an addition product from unsaturated fatty acids and unsaturated monomers with another substance, and then an emulsion polymerization of unsaturated monomers is carried out with this solution polymer. According to the invention, the degree of neutralization of the solution polymer is set before the emulsion polymerization by admixture of a base.

Oxidative drying oils, however, require substances and/or additives of ecological concerns, for example cobalt catalysts. Furthermore, if such stains or coatings contain components of biological origin they may suffer from inconsistent quality and non-reproducible properties that are due to year-to-year or regional climate fluctuations resulting in a differing composition of the single components of the biological sources (e.g., relative ratios of saturated and unsaturated fatty acids).

EP 3088432 describes an aqueous dispersion obtained by a process comprising steps of (a) preparing an acidic copolymer (A) by radical copolymerization and (b) neutralizing the acid groups of copolymer (A) and dissolving it in water, (c) copolymerizing in the solution obtained at step (b) a monomer mixture different from the monomer mixture of step (a) to form a copolymer (B). The monomers used in step (a) comprise (a1) at least one unsaturated fatty acid such as soybean oil fatty acids and linseed oil fatty acids, (a2) at least one ethylenically unsaturated monomer containing at least one acid group such as (meth)acrylic acid, and (a3) at least one other ethylenically unsaturated monomer different from (a1) and (a2) such as styrene, (meth)acrylamide, diacetone (meth)acrylamide, isobornyl (meth)acrylate and methyl methacrylate. Monomers used at step (c) comprise at least one monomer mixture different from the monomer mixture of step (a), such as 2-ethylhexyl acrylate, butyl acrylate and methyl methacrylate. The aqueous dispersion compositions described therein are suitable as coating agents or binder agents for decorative and protective coating applications on various substrates.

EP 2410000, EP 2410028 as well as WO 2013/013701 teach mixtures of acrylic resin dispersion and polyurethane dispersion as aqueous coating composition or as useful for preparing binders for coating composition. These coatings do not penetrate into the wood but provide a barrier coating on the surface of the wood. Therefore, they are not suitable for achieving protection of the interior of the wood. Rather, they degrade or will be leached if exposed to weathering. The acrylic resins described therein show rather low amount of acid groups and high molecular weight.

### SUMMARY OF THE INVENTION

Yet, there is still need to improve the properties of staining composition for wood or wooden materials in terms of weather resistance. Especially, the wood stain composition should result in good coating properties, such as excellent weather resistance, high mechanical strength and durability. At the same time, the wood stain composition should be storage stable, in particular against formation of coagulum and increase in viscosity, and show good filming properties. Furthermore, the wood stain composition should not involve substances of ecological concerns and/or treatments requiring such harmful substances. Even if the compositions contain components of biological origin they should provide reliable and consistent quality and reproducible properties.

Surprisingly, it was found that aqueous polymer compositions containing a water-soluble or water-dispersible polymer P made of polymerized ethylenically unsaturated monomers M provide improved durability and weather resistance to wooden materials and therefore can be used in staining compositions. Furthermore, it was found that a use of said aqueous polymer composition in wood stain compositions does not require substances of ecological concerns and/or treatments requiring such harmful substances. In addition, it was also surprisingly found that said aqueous polymer composition provides reliable and consistent quality and reproducible properties, not only when said composition solely consists of components of synthetic origin but also, if the contained components are of biological origins.

It was further surprisingly found that said aqueous polymer composition is equally applicable for porous materials other than wood or wooden materials, such as concrete, gypsum board, sponges and rubbers.

The aqueous polymer composition as a staining composition for porous materials contains a water-soluble or water dispersible polymer P made of polymerized ethylenically unsaturated monomers M comprising
30 to 90 wt.-%, based on the total weight of monomers M, of at least one monomer M1 selected from C₁-C₁₂-alkyl esters of monoethylenically unsaturated carboxylic acids, C₆-C₁₀-cycloalkyl esters of monoethylenically unsaturated carboxylic acids and monovinylaromatic hydrocarbon monomers,
5 to 30 wt.-%, based on the total weight of monomers M, of at least one monomer M2 selected from monoethylenically unsaturated monomers containing at least one acid group, and
5 to 40 wt.-%, based on the total weight of monomers M, of at least one monomer M3 different from M2 which has a reactive functional group being capable of being crosslinked,
wherein the total weight of monomers M1, M2 and M3 corresponds to at least 90% of the total weight of monomers M;
wherein the monomers M are selected such that the theoretical glass transition temperature according to Fox (Tg^{t}) of the polymer P is at most 80° C.; and
wherein the polymer P is dissolved or dispersed in an aqueous phase such that the acid groups of the polymer P are totally or partially neutralized.

The present invention therefore relates to a use of said aqueous polymer compositions as a staining composition for porous materials.

According to a particular preferred embodiment of the invention, the porous materials are wood or wooden materials.

The present invention further relates to an aqueous polymer composition, which contains a water-soluble or water dispersible polymer P as described herein and a crosslinking agent as described herein, wherein the polymer P amounts for at least 90% of the total mass of polymers present in the aqueous polymer composition.

The present invention is associated with several benefits.
The aqueous polymer compositions are stable and penetrate into the treated wood and thus provide a durable protection of the treated wood. Therefore, they are particular useful as stains.
The use of the aqueous polymer compositions shows reduced leaching from the treated wooden material, in particular if used in combination with crosslinking agents, and do not require the use of ecologically harmful substances.
In particular, staining compositions based on the aqueous polymer compositions provide a durable protection against mechanical and weathering stresses, i.e., good weather resistance, in particular against moisture, UV radiation, and improved whitening resistance.
The aqueous polymer compositions are compatible with crosslinking agents. Therefore, the durability of the protection can be readily increased by using crosslinking agents.
Even if the aqueous polymer compositions contain components of biological origin they provide reliable and consistent quality and reproducible properties compared to the corresponding compositions solely consisting of components of synthetic origin.
The aqueous polymer composition is equally applicable for porous materials other than wood or wooden materials, such as concrete, gypsum board, sponges and rubbers.

The compositions of the present invention is particularly useful for impregnating construction timber for the construction of wooden houses, for framework construction, for the construction of roof constructions, for the construction of buildings of post and beam construction, for the construction of bridges, viewing platforms or carports, and for parts of buildings, such as patios, balconies, balcony railings, dormer windows, and the like. This includes in addition the use of modified wood materials for the construction of staircases, including steps, e.g. in wooden steps in metal staircase constructions but also for staircases and banisters manufactured completely from wood materials.

The compositions of the present invention is also useful for impregnating wood or wooden material used for garden construction, for example for the manufacture of fences, palisades, sight screen components, summer houses, pergolas, aviaries, balcony, terraces, and the like. The compositions of the present invention is particularly useful for impregnating wooden floorboards and wooden planks, e.g. for the production of hardwood plank parquet and terrace floorings.

### DETAILED DESCRIPTION OF THE INVENTION

Here and throughout the specification, the term “porous materials” refers to a material containing pores (voids) whose pore diameters are typically in the range of 50 to 200 μm.

Examples of suitable porous materials are, but not limited to, wood or wooden materials, but also non-wooden materials such as concrete, gypsum board, sponges and rubbers.

Wood in terms of the present invention include any wood, which may be untreated or treated, in particular untreated. It includes softwood and hardwood. The term “softwood” includes for example willow, poplar, lime/linden and most conifers such as spruce and pine. The term “hardwood” includes for example acacia, angelim, bangkirai, ekki, bilinga, cumaru, Douglas fir, eucalyptus, fava, garapa, ipe, iroko, itauba, jatoba, karri, limbali, massaranduba, mukulungu, okan, piquia, robinia, tali, tatajuba, torrado, oak or teak.

Here and throughout the term “wooden material” is to be understood as follows: wooden materials are made of wood particles and/or veneers which are glued together to form the wooden material.

Wooden materials include but are not limited to oriented strand (OSB) boards, particle boards, one side laminated particle (OSL) boards, parallel strand lumber (PSL) boards, insulating boards and medium-density (MDF) and high-density (HDF) fiber boards, and the like, and also veneer lumber, such as veneered fiber boards, veneered block boards, veneered particle boards, including veneered OSL and PSL boards, plywood, glued wood, laminated wood or veneered laminated wood (e.g. kerto laminated wood).

Here and throughout the term “quality” is to be understood that the staining composition possesses proper properties and characteristics that are required to such staining composition and therefore is capable to provide properties, such as durability or weather resistance, to porous materials on which the staining composition is applied.

Here and throughout the specification, the term “polymer” refers to a substance consisting of very large molecules, or macromolecules, which have high relative molecular masses and comprise the multiple repetition of units derived, actually or conceptually, from molecules of low relative molecular mass, i.e., monomer. Therefore, in the context of the present invention, the term “polymer” encompasses polymers formed from one single monomers, i.e., homopolymer and polymers formed from two or more, for example 3 or 4, different monomers, i.e., copolymer.

Here and throughout the specification, the term “ethylenically unsaturated monomer” is understood that the monomer has at least one C═C double bond, e.g., 1, 2, 3 or 4 C═C double bonds, which are radically polymerizable, i.e., which under the conditions of an aqueous radical emulsion polymerization process are polymerized to obtain a polymer having a backbone of carbon atoms. Here and throughout the specification, the term “monoethylenically unsaturated” is understood that the monomer has a single C═C double bond, which is susceptible to radical polymerization under conditions of an aqueous radical emulsion polymerization.

Here and throughout the specification, the prefixes “Cₙ-Cₘ” used in connection with compounds or molecular moieties each indicate a range for the number of possible carbon atoms that a molecular moiety or a compound can have. The term “C₁-Cₙ alkyl” denominates a group of linear or branched saturated hydrocarbon radicals having from 1 to n carbon atoms. The term “Cₙ/Cₘ alkyl” denominates a mixture of two alkyl groups, one having n carbon atoms, while the other having m carbon atoms.

For example, the term “C₁-C₁₂ alkyl” denominates a group of linear or branched saturated hydrocarbon radicals having from 1 to 10 carbon atoms. Examples of alkyl include, but are not limited to methyl, ethyl, n-propyl, isopropyl, n-butyl, sec-butyl, isobutyl, tert-butyl, 2-methylpropyl (isobutyl), 1,1-dimethylethyl (tert-butyl), pentyl, 1-methylbutyl, 2-methylbutyl, 3-methylbutyl, 2,2-dimethylpropyl, 1-ethylpropyl, hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, heptyl, octyl, 1-methylheptyl (2-octyl), 2-ethylhexyl, nonyl, isononyl, decyl, their isomers, in particular mixtures of isomers, such as “isononyl”, “isodecyl”, n-undecyl and n-dodecyl.

The term “C₆-C₁₀-cycloalkyl” as used herein refers to a mono- or bicyclic cycloaliphatic radical which is unsubstituted or substituted by 1, 2, 3 or 4 methyl radicals, where the total number of carbon atoms of C₆-C₁₀-cycloalkyl from 6 to 10. Examples of C₆-C₁₀-cycloalkyl include but are not limited to cyclohexyl, methylcyclohexyl, dimethylcyclohexyl, cycloheptyl, cyclooctyl, norbornyl (=bicyclo[2.2.1]heptyl) and isobornyl (=1,7,7-trimethylbicyclo[2.2.1]heptyl).

Here and throughout the specification, the terms “wt.-%”, “wt. %”, “weight percent” and “% by weight” are used synonymously.

Here and throughout the specification, the term “pphm” (parts per hundred monomers) is used as a synonym for the relative amount of a certain monomer to the total amount of monomer in % by weight.

Here and throughout the specification, the term “(meth)acryl” includes both acryl and methacryl groups. Hence the term “(meth)acrylate” includes acrylate and methacrylate and the term “(meth)acrylamide” includes acrylamide and methacrylamide.

Here and throughout the specification, the term “room temperature” means a temperature of about 22° C.

Here and throughout the specification, the term “aqueous polymer composition” refers to a solution or a dispersion of polymers in a liquid carrier medium of which water is the principal component. The amount of water in the aqueous polymer composition corresponds to at least 50%, preferably at least 80%, more preferably at least 95% and most preferably at least 98% of the total weight of liquid carrier medium. Minor amounts of organic liquids may optionally be present although it is preferred that the aqueous composition is substantially solvent-free, by which is meant that the composition contains less than 5 wt.-%, more preferably less than 2 wt.-%, based on the total weight of liquid carrier medium, of organic solvent(s) and most preferably no solvent at all.

In the context of the present invention, the “water-soluble or water-dispersible polymer” is understood that the polymer forms a stable colloidal solution in water at standard conditions, i.e., in deionized water at 20° C. and 1013 mbar.

In other words, in the context of the present invention, the term “water-soluble or water-dispersible” is understood that the corresponding copolymer can be dissolved or dispersed in deionized water at 20° C. and 1013 mbar in an amount of at least 10 g/L polymer such that the resulting aqueous solution or dispersion has either no measurable particle size or a particle size of at most 300 nm as determined at a temperature in the range of 20 to 25° C. by hydrodynamic chromatography fractionation (HDC). More particularly, the copolymer is water-soluble or water-dispersible, i.e. if it can be dissolved or dispersed in deionized water at 20° C. and 1013 mbar in an amount of at least 10 g/L, such that the resulting aqueous solution is virtually transparent or translucent, i.e. the turbidity of the solution, as expressed in light transmittance (LD100 value), as determined photometrically with 1 cm cuvette, is at least 0.05, preferably at least 0.1, more preferably at least 0.2.

The water-soluble or water dispersible copolymer P is made of polymerized ethylenically unsaturated monomers, hereinafter monomers M as defined herein. Accordingly, the polymer backbone is formed by repeating units of the respective monomers M, which comprise the combination of monomers M1, M2, and M3 and optionally M4, if present in the amounts given herein.

Preferably, the monomers M comprise the combination of monomers M1, M2, and M3 in an amount of at least 95 wt.-%, in particular at least 98 wt.-% especially at least 99 wt.-%, based on the total amount of monomers M and thus, based on the total amount of monomers M which form the polymer P.

According to the invention the monomers M comprise at least one monoethylenically unsaturated monomer M1. Monomer M1 is selected from C₁-C₁₂-alkyl esters of monoethylenically unsaturated carboxylic acids, C₆-C₁₀-cycloalkyl esters of monoethylenically unsaturated carboxylic acids and monovinylaromatic hydrocarbon monomers.

Suitable C₁-C₁₂-alkyl esters of monoethylenically unsaturated monocarboxylic acids are in particular C₁-C₁₂-alkyl esters of acrylic acids and C₁-C₁₂-alkyl esters of methacrylic acids. Examples of suitable C₁-C₁₂-alkyl esters of acrylic acids include, but are not limited to methyl acrylate, ethyl acrylate, n-propyl acrylate, isopropyl acrylate, n-butyl acrylate, sec-butyl acrylate, isobutyl acrylate, tert-butyl acrylate, n-pentyl acrylate, isopentyl acrylate, 2-methylbutyl acrylate, n-hexyl acrylate, n-octyl acrylate, 2-octylacrylate, 2-ethylhexyl acrylate, 2-propylheptyl acrylate, n-decyl acrylate, isodecyl acrylate, lauryl acrylate, and mixtures thereof.

Suitable C₁-C₁₂-alkyl esters of methacrylic acids include, but are not limited to methyl methacrylate, ethyl methacrylate, n-propyl methacrylate, isopropyl methacrylate, n-butyl methacrylate, sec-butyl methacrylate, isobutyl methacrylate, tert-butyl methacrylate, n-pentyl methacrylate, isopentyl methacrylate, 2-pentyl methacrylate, n-hexyl methacrylate, n-octyl methacrylate, 2-octyl methacrylate, 2-ethylhexyl methacrylate, 2-propylheptyl methacrylate, n-decyl methacrylate, isodecyl methacrylate, lauryl methacrylate, and mixtures thereof.

Suitable C₆-C₁₀-cycloalkyl esters of monoethylenically unsaturated monocarboxylic acids are in particular C₆-C₁₀-cycloalkyl esters of acrylic acids and C₆-C₁₀-cycloalkyl esters of methacrylic acids. Examples of suitable C₆-C₁₀-cycloalkyl esters of acrylic acids include but are not limited to cyclohexyl acrylate, norbornyl acrylate and isobornyl acrylate. Examples of suitable C₆-C₁₀-cycloalkyl esters of methacrylic acids include but are not limited to cyclohexyl methacrylate, norbornyl methacrylate and isobornyl methacrylate.

Suitable monovinylaromatic hydrocarbon monomers are in particular styrene and styrenic derivatives. Examples of suitable styrenic derivatives include, but are not limited to styrene substituted with 1 or 2 substituents selected from the group consisting of halogen, OH, CN, NO₂, phenyl and C₁-C₄-alkyl, examples including vinyltoluene, alpha-methylstyrene, ethylstyrene, isopropylstyrene, tert-butylstyrene, 2,4-dimethylstyrene, diethylstyrene, o-methyl-isopropylstyrene, chlorostyrene, fluorostyrene, iodostyrene, bromostyrene, 2,4-cyanostyrene, hydroxystyrene, nitrostyrene, phenylstyrene. The particularly preferred monovinylaromatic hydrocarbon monomer is styrene.

Preferably, the amount of monovinylaromatic hydrocarbon monomers does not exceed 25 wt.-%, particularly 20 wt.-%, especially 15 wt.-%, based on the total weight of monomers M. In a particular preferred group of embodiments, the monomers M1 do not contain any monovinylaromatic hydrocarbon monomers or less than 5 wt.-% of monovinylaromatic hydrocarbon monomers, based on the total weight of monomers M. In another group of embodiments, the monomers M1 contain 1 to 25 wt.-%, in particular 5 to 20 wt.-% of at least one monovinylaromatic hydrocarbon monomer, based on the total weight of monomers M.

In a preferred group of embodiments, the monomers M1 comprise or consist of
at least one monomer M1.a, selected from the group consisting of C₁-C₆-alkyl esters of monoethylenically unsaturated monocarboxylic acids such as C₁-C₆-alkyl esters of acrylic acids and C₁-C₆-alkyl esters of methacrylic acids; and
optionally one or more monomers M1.b selected from the group consisting of.
   C₆-C₁₀-cycloalkyl esters of monoethylenically unsaturated monocarboxylic acids such as C₆-C₁₀-cycloalkyl esters of acrylic acids and the C₆-C₁₀-cycloalkyl esters of methacrylic acids, and
   C₇-C₁₀-alkyl esters of monoethylenically unsaturated monocarboxylic acids such as C₇-C₁₀-alkyl esters of acrylic acids and C₇-C₁₀-alkyl esters of methacrylic acids.

In particular, the monomers M1 comprise or consist of
at least one monomer M1.a, selected from the group consisting of C₁-C₆-alkyl esters of acrylic acids and C₁-C₆-alkyl esters of methacrylic acids such as methyl acrylate, ethyl acrylate, n-propyl acrylate, isopropyl acrylate, n-butyl acrylate, sec-butyl acrylate, isobutyl acrylate, tert-butyl acrylate, n-pentyl acrylate, isopentyl acrylate, 2-pentyl methacrylate, n-hexyl acrylate, methyl methacrylate, ethyl methacrylate, n-propyl methacrylate, isopropyl methacrylate, n-butyl methacrylate, sec-butyl methacrylate, isobutyl methacrylate, tert-butyl methacrylate, n-pentyl methacrylate, isopentyl methacrylate, 2-pentyl methacrylate, n-hexyl methacrylate, and mixtures thereof; and
optionally one or more monomers M1.b, selected from the group consisting of.
   C₆-C₁₀-cycloalkyl esters of acrylic acids and the C₆-C₁₀-cycloalkyl esters of methacrylic acids such as cyclohexyl acrylate, norbornyl acrylate and isobornyl acrylate, cyclohexyl methacrylate, norbornyl methacrylate and isobornyl methacrylate,
   C₇-C₁₀-alkyl esters of acrylic acids and C₇-C₁₀-alkyl esters of methacrylic acids, such as n-octyl acrylate, 2-octyl acrylate, 2-ethylhexyl acrylate, 2-propylheptyl acrylate, n-decyl acrylate, isodecyl acrylate, lauryl acrylate, n-octyl methacrylate, 2-ethylhexyl methacrylate, 2-propylheptyl methacrylate, n-decyl methacrylate, isodecyl methacrylate, lauryl methacrylate and mixtures thereof.

In another preferred group of embodiments, the monomers M1 comprise or consist of
at least one monomers M1.a selected from the group consisting of C₁-C₆-alkyl esters of monoethylenically unsaturated monocarboxylic acids such as C₁-C₆-alkyl esters of acrylic acids and C₁-C₆-alkyl esters of methacrylic acids; and
optionally one or more monomers M1.b selected from the group consisting of C₆-C₁₀-cycloalkyl esters of monoethylenically unsaturated monocarboxylic acids such as C₆-C₁₀-cycloalkyl esters of acrylic acids and the C₆-C₁₀-cycloalkyl esters of methacrylic acids,
C₇-C₁₀-alkyl esters of monoethylenically unsaturated monocarboxylic acids such as C₇-C₁₀-alkyl esters of acrylic acids and C₇-C₁₀-alkyl esters of methacrylic acids, and
at least one monomer M1.c, selected from the group consisting of monovinylaromatic hydrocarbon monomers in particular styrene;
where the amount of the monomers M1.c is preferably in the range of 1 to 25 wt.-%, in particular in the range of 5 to 20 wt.-%, based on the total weight of monomers M.

In this other preferred group of embodiments, the monomers M1 comprises
at least one monomer M1.a, selected from the group consisting of C₁-C₆-alkyl esters of acrylic acids and C₁-C₆-alkyl esters of methacrylic acids such as methyl acrylate, ethyl acrylate, n-propyl acrylate, isopropyl acrylate, n-butyl acrylate, sec-butyl acrylate, isobutyl acrylate, tert-butyl acrylate, n-pentyl acrylate, isopentyl acrylate, 2-pentyl methacrylate, n-hexyl acrylate, methyl methacrylate, ethyl methacrylate, n-propyl methacrylate, isopropyl methacrylate, n-butyl methacrylate, sec-butyl methacrylate, isobutyl methacrylate, tert-butyl methacrylate, n-pentyl methacrylate, isopentyl methacrylate, 2-pentyl methacrylate, n-hexyl methacrylate, and mixtures thereof; and
optionally one or more monomers M1.b, selected from the group consisting of
   C₆-C₁₀-cycloalkyl esters of acrylic acids and the C₆-C₁₀-cycloalkyl esters of methacrylic acids such as cyclohexyl acrylate, norbornyl acrylate and isobornyl acrylate, cyclohexyl methacrylate, norbornyl methacrylate and isobornyl methacrylate,
   C₇-C₁₀-alkyl esters of acrylic acids and C₇-C₁₀-alkyl esters of methacrylic acids, such as n-octyl acrylate, 2-octyl acrylate, 2-ethylhexyl acrylate, 2-propylheptyl acrylate, n-decyl acrylate, isodecyl acrylate, lauryl acrylate, n-octyl methacrylate, 2-ethylhexyl methacrylate, 2-propylheptyl methacrylate, n-decyl methacrylate, isodecyl methacrylate, lauryl methacrylate and mixtures thereof.
at least one monomer M1.c, which is styrene;
where the amount of the monomers M1.c is preferably in the range of 1 to 25 wt.-%, in particular in the range of 5 to 20 wt.-%, based on the total weight of monomers M.

In the mixtures of monomers M1.a and M1.b, the relative amount of M1.a and M1.b may vary in particular from 10:1 to 1:10, more particularly from 5:1 to 1:5. The ratio of monomers M1.a to M1.b will affect the glass transition temperature and a proper mixture will result in the desired glass transition temperatures.

The total amount of monomers M1 is frequently from 40 to 85% by weight or from 40 to 80% by weight and especially from 50 to 80% by weight or from 50 to 78% by weight, based on the total weight of the monomers M.

According to the invention the monomers M comprise at least one monoethylenically unsaturated monomer M2. M2 is selected from monoethylenically unsaturated monomers containing at least one acid group. Suitable acid groups include carboxyl groups, sulfonyl groups, sulfonate, phosphate and phosphonate.

Preferably, the monomers M2 are selected from the group consisting of
monoethylenically unsaturated monocarboxylic acids having 3 to 6 carbon atoms; and
monoethylenically unsaturated dicarboxylic acids having 4 to 6 carbon atoms.

For example, suitable monomers M2 include, but are not limited to
monoethylenically unsaturated monocarboxylic acids having 3 to 6 carbon atoms, such as acrylic acid, methacrylic acid, crotonic acid, 2-ethylpropenoic acid, 2-propylpropenoic acid, 2-acryloxyacetic acid and 2-methacryloxyacetic acid; and
monoethylenically unsaturated dicarboxylic acids having 4 to 6 carbon atoms, such as itaconic acid, mesaconic acid, citraconic acid and fumaric acid.

Amongst the aforementioned monomers M2, preference is given to monoethylenically unsaturated monocarboxylic acids. Particular preference is given to acrylic acid, methacrylic acid and mixtures thereof. In a particular group of embodiments, the monomer M2 comprises methacrylic acid. More particularly, the monomer M2 is methacrylic acid or a mixture of acrylic acid and methacrylic acid. Especially, the monomer M2 is methacrylic acid.

The total amount of monomers M2 is generally from 5 to 30% by weight, in particular from 7 to 25% by weight, preferably from 8 to 20% by weight, especially from 9 to 15% by weight, based on the total weight of the monomers M.

According to the invention the monomers M comprise at least one at least one monomer M3 different from M2, which has a reactive functional group being capable of being crosslinked.

Suitable monomers M3 are monoethylenically unsaturated monomers, wherein the reactive functional group of the monomers M3 is selected from the group consisting of urea groups, keto groups, aldehyde groups and epoxy groups. Preferably, the reactive functional group of the monomers M3 is selected from the group consisting of urea groups and keto groups.

Therefore, in a preferred group of embodiments, monomers M3 are selected from the group consisting of monoethylenically unsaturated monomers bearing a urea group (hereinafter monomers M3.a) and monoethylenically unsaturated monomers bearing a keto group (hereinafter monomers M3.b).

Examples for monomers M3 bearing a urea group (M3.a) include, but are not limited to C₁-C₄-alkyl esters of acrylic acid and methacrylic acid, and N—C₁-C₄-alkyl amides of acrylic acid and methacrylic acid, where the C₁-C₄-alkyl group bears an urea group or a 2-oxoimidazolin group such as 2-(2-oxo-imidazolidin-1-yl) ethyl acrylate, 2-(2-oxo-imidazolidin-1-yl) ethyl methacrylate, which are also termed 2-ureido acrylate and 2-ureido methacrylate, respectively, N-(2-methacrylamidoethyl) imidazolin-2-on, N-(2-acryloxyethyl) imidazolin-2-on, N-(2-methacryloxyethyl) imidazolin-2-on, N-(2-(2-oxo-imidazolidin-1-yl) ethyl) acrylamide, N-(2-(2-oxo-imidazolidin-1-yl)ethyl) methacrylamide, as well as allyl or vinyl substituted ureas and allyl or vinyl substituted 2-oxoimidazolin compounds such as 1-allyl-2-oxoimidazolin, N-allyl urea and N-vinylurea.

In particular, monomers M3.a are selected from the group consisting of N-(2-methacrylamidoethyl) imidazolin-2-on (commercially available as Sipomer® WAM II) and N-(2-methacryloxyethyl) imidazolin-2-on (also as known as ureido methacrylate, UMA).

Examples for monomers M3 bearing a keto group (M3.b) include, but are not limited to
M3.b.1) C₂-C₈-oxoalkyl esters of acrylic acids or methacrylic acids, and N—C₂-C₈-oxoalkyl amides of acrylic acids or methacrylic acids, such as diacetoneacrylamide (DAAM), and diacetonemethacrylamide, and
M3.b.2) C₁-C₄-alkyl esters of acrylic acids or methacrylic acids, and N—C₁-C₄-alkyl amides of acrylic acids or methacrylic acids, where the C₁-C₄-alkyl group bears a 2-acetylacetoxy group of the formula O—C(═O)—CH₂—C(═O)—CH₃ (also termed acetoacetoxy group), such as acetoacetoxyethyl acrylate, acetoacetoxypropyl methacrylate, acetoacetoxybutyl methacrylate and 2-(acetoacetoxy) ethyl methacrylate (AAEM).

In particular, monomers M3.b are selected from the group consisting of diacetoneacrylamide (DAAM), diacetonemethacrylamide, 2-(acetoacetoxy) ethyl acrylate, 2-(acetoacetoxy) ethyl methacrylate (AAEM), acetoacetoxypropyl acrylate, acetoacetoxypropyl methacrylate, acetoacetoxybutyl acrylate and acetoacetoxybutyl methacrylate.

In a preferred embodiment, the monomer M3 is selected from the group consisting of
M3.a) C₁-C₄-alkyl esters of acrylic acid or methacrylic acid and the N—C₁-C₄-alkyl amides of acrylic acid or methacrylic acid, wherein the C₁-C₄-alkyl group bears a urea group; and
M3.b.1) C₂-C₈-oxoalkyl esters of acrylic acid or methacrylic acid, N—C₂-C₈-oxoalkyl amides of acrylic acid or methacrylic acid,
M3.b.2) C₁-C₄-alkyl esters of acrylic acid or methacrylic acid, and N—C₁-C₄-alkyl amides of acrylic acid or methacrylic acid, wherein the C₁-C₄-alkyl group bears a 2-acetylacetoxy group of the formula O—C(═O)—CH₂—C(═O)—CH₃.

Examples for monomers M3 bearing an aldehyde group (hereinafter monomers M3.c) include, but are not limited to acrolein, methacrolein, formylstyrene and 6-(methacryloxy) hexanal.

Suitable monomers M3 bearing an epoxy group (hereinafter monomers M3.d), in particular a glycidyl group include, but are not limited to glycidyl acrylate and glycidyl methacrylate.

In particular, the monomers M3 are selected from monomers M3.a, especially N-(2-methacrylamidoethyl) imidazolin-2-on, N-(2-methacryloxyethyl) imidazolin-2-on, monomers M3.b, especially diacetoneacrylamide (DAAM), 2-(acetoacetoxy) ethyl methacrylate (AAEM) and combinations thereof.

The total amount of monomers M3 is generally from 5 to 40% by weight, in particular from 7 to 35% by weight, especially from 8 to 30% by weight, based on the total weight of the monomers M.

Optionally, the monomers M may further comprise at least one monoethylenically unsaturated non-ionic monomer M4, which is water soluble and different from the monomers M1, M2 and M3.

The term “water-soluble” with regard to monoethylenically unsaturated monomers M4 is well understood to mean that the monomer M4, has a solubility in deionized water at 20° C. and 1 bar of at least 60 g/L, in particular at least 80 g/L.

Examples for monomers M4 include, but are not limited to monoethylenically unsaturated non-ionic monomers having a hydroxy-C₂-C₄-alkyl group, such as
the hydroxy-C₂-C₄-alkyl esters of monoethylenically unsaturated monocarboxylic acids having 3 to 6 carbon atoms, in particular the hydroxy-C₂-C₄-alkyl esters of acrylic acid and the hydroxy-C₂-C₄-alkyl esters of methacrylic acid, such as 2-hydroxyethyl acrylate, 2-hydroxypropyl acrylate, 3-hydroxylpropyl acrylate, 2-hydroxybutyl acrylate, 4-hydroxybutyl acrylate, 2-hydroxyethyl methacrylate (HEMA), 2-hydroxypropyl methacrylate, 3-hydroxylpropyl methacrylate, 2-hydroxybutyl methacrylate and 4-hydroxybutyl methacrylate,
polyalkylenglykol esters of monoethylenically unsaturated monocarboxylic acids having 3 to 6 carbon atoms, in particular methoxypolyethyleneglycol methacrylates of different chain lengths like Bisomer® MPEG 350 MA, Bisomer® MPEG 550 MA, Bisomer® S 7 W, Bisomer® S 10 W and Bisomer® S 20 W,
primary amides of monoethylenically unsaturated monocarboxylic acids having 3 to 6 carbon atoms, such as acrylamide and methacrylamide, and
C₁-C₄-alkylamides of monoethylenically unsaturated monocarboxylic acids having 3 to 6 carbon atoms, such as N-methyl acrylamide, N ethyl acrylamide, N-propyl acrylamide, N-isopropyl acrylamide, N-butyl acrylamide, N-methyl methacrylamide, N-ethyl methacrylamide, N-propyl methacrylamide, N isopropyl methacrylamide and N-butyl methacrylamide.

The amount of monomers M4 will not exceed 10% by weight, based on the total weight of the monomers M, and is preferably at most 5% by weight, in particular at most 2% by weight and especially at most 1% by weight or 0% by weight.

According to the invention, the monomers M comprise:
30 to 90% by weight or from 40 to 85% by weight or from 40 to 80% by weight and especially from 50 to 80% by weight or from 50 to 78% by weight, based on the total weight of the monomers M, of at least one monomer M1 selected from C₁-C₁₂-alkyl esters of monoethylenically unsaturated carboxylic acids, C₆-C₁₀-cylcloalkyl esters of monoethylenically unsaturated carboxylic acids and monovinylaromatic hydrocarbon monomers, where the amount of monovinylaromatic hydrocarbon monomers preferably does not exceed 25% by weight, based on the total weight of the monomers M;
5 to 30% by weight, in particular from 7 to 25% by weight, preferably from 8 to 20% by weight, especially from 9 to 15% by weight, based on the total weight of the monomers M, of at least one monomer M2 selected from monoethylenically unsaturated monomers containing at least one acid group; and
5 to 40% by weight, in particular from 7 to 35% by weight, especially from 8 to 30% by weight, based on the total weight of the monomers M of at least one monomer M3 different from M2 which has a reactive functional group being capable of being crosslinked.

In a preferred embodiment, the monomers M comprise:
40 to 85% by weight or 40 to 80% by weight and especially from 50 to 80% by weight or from 50 to 78% by weight, based on the total weight of the monomers M, of at least two monomers M1 comprising
   at least one monomer M1.a selected from the group consisting of
      C₁-C₆-alkyl esters of acrylic acids and C₁-C₆-alkyl esters of methacrylic acids such as methyl acrylate, ethyl acrylate, n-propyl acrylate, isopropyl acrylate, n-butyl acrylate, sec-butyl acrylate, isobutyl acrylate, tert-butyl acrylate, n-pentyl acrylate, isopentyl acrylate, n-hexyl acrylate, methyl methacrylate, ethyl methacrylate, n-propyl methacrylate, isopropyl methacrylate, n-butyl methacrylate, sec-butyl methacrylate, isobutyl methacrylate, tert-butyl methacrylate, n-pentyl methacrylate, isopentyl methacrylate, n-hexyl methacrylate, and mixtures thereof;
   optionally one or more monomers M1.b selected from the group consisting of
      C₆-C₁₀-cycloalkyl esters of acrylic acids and the C₆-C₁₀-cycloalkyl esters of methacrylic acids such as cyclohexyl acrylate, norbornyl acrylate and isobornyl acrylate, cyclohexyl methacrylate, norbornyl methacrylate and isobornyl methacrylate,
      C₇-C₁₀-alkyl esters of acrylic acids and C₇-C₁₀-alkyl esters of methacrylic acids, such as n-octyl acrylate, 2-ethylhexyl acrylate, 2-propylheptyl acrylate, n-decyl acrylate, isodecyl acrylate, lauryl acrylate, n-octyl methacrylate, 2-ethylhexyl methacrylate, 2-propylheptyl methacrylate, n-decyl methacrylate, isodecyl methacrylate, lauryl methacrylate, and mixtures thereof;
   and optionally styrene, where the amount of styrene preferably does not exceed 25% by weight, based on the total weight of the monomers M;
5 to 30% by weight, in particular from 7 to 25% by weight, preferably from 8 to 20% by weight, especially from 9 to 15% by weight, based on the total weight of the monomers M, of at least one monomer M2 selected from the group consisting of monoethylenically unsaturated monomers containing at least one acid group, preferably from the group consisting of acrylic acid, methacrylic acid and mixtures thereof, more preferably from methacrylic acid; and
5 to 40% by weight, in particular from 7 to 35% by weight, especially from 8 to 30% by weight, based on the total weight of the monomers M of at least one monomer M3 different from M2 which has a reactive functional group being capable of being crosslinked and which is preferably selected from the group consisting of monomers M3.a, M3.b and M3.c and combinations thereof, more preferably selected from the group consisting of N-(2-methacryloxyethyl) imidazolin-2-on (UMA), diacetoneacrylamide (DAAM), 2-(acetoacetoxy) ethyl methacrylate (AAEM), and mixtures thereof.

In preferred embodiments, the monomers M comprise or consist of:
40 to 85% by weight or from 40 to 80% by weight and especially from 50 to 80% by weight or from 50 to 78% by weight, based on the total weight of the monomers M, of at least two monomers M1 comprising.
   at least one monomer M1.a selected from the group consisting of n-butyl acrylate, methyl methacrylate, n-butyl methacrylate, and mixtures thereof;
   and optionally one or more monomers M1.b, selected from the group consisting of cyclohexyl methacrylate, 2-ethylhexyl acrylate and mixtures thereof.
5 to 30% by weight, in particular from 7 to 25% by weight, preferably from 8 to 20% by weight, especially from 9 to 15% by weight, based on the total weight of the monomers M, of at least one monomer M2 which is methacrylic acid; and
5 to 40% by weight, in particular from 7 to 35% by weight, especially from 8 to 30% by weight, based on the total weight of the monomers M, of at least one monomer M3 different from M2 which has a reactive functional group being capable of being crosslinked and which is preferably selected from the group consisting of N-(2-methacryloxyethyl) imidazolin-2-on (UMA), diacetoneacrylamide (DAAM), 2-(acetoacetoxy) ethyl methacrylate (AAEM), and mixtures thereof.

In other preferred embodiments, the monomers M comprise or consist of:
40 to 85% by weight or from 40 to 80% by weight and especially from 50 to 80% by weight or from 50 to 78% by weight, based on the total weight of the monomers M, of at least two monomers M1 comprising
   at least one monomer M1.a selected from the group consisting of n-butyl acrylate, methyl methacrylate, n-butyl methacrylate, and mixtures thereof;
   optionally one or more monomers M1.b, selected from the group consisting of cyclohexyl methacrylate, 2-ethylhexyl acrylate and mixtures thereof and
   styrene, where the amount of styrene is preferably in the range of 1 to 25 wt.-%, in particular in the range of 5 to 20 wt.-%, based on the total weight of monomers M;
5 to 30% by weight, in particular from 7 to 25% by weight, preferably from 8 to 20% by weight, especially from 9 to 15% by weight, based on the total weight of the monomers M, of at least one monomer M2 which is methacrylic acid; and
5 to 40% by weight, in particular from 7 to 35% by weight, especially from 8 to 30% by weight, based on the total weight of the monomers M, of at least one monomer M3 different from M2 which has a reactive functional group being capable of being crosslinked and which is preferably selected from the group consisting of N-(2-methacryloxyethyl) imidazolin-2-on (UMA), diacetoneacrylamide (DAAM), 2-(acetoacetoxy) ethyl methacrylate (AAEM), and mixtures thereof.

The polymer P has a glass transition temperature according to Fox (Tg^{t}) which is at most 80° C., preferably at most 60° C., in particular at most 40° C., e.g. in the range from −40 to +80° C., in particular in the range from 0 to +60° C., especially in the range from 10 to +40° C.

The glass transition temperature as referred to herein is determined by the DSC method (differential scanning calorimetry) using a heating rate of 20 K/min and applying the midpoint measurement in accordance with ISO 11357-2:2013-05, with sample preparation in accordance with DIN EN ISO 16805:2005-07. The copolymer P has a glass transition temperature, as determined by differential scanning calorimetry, of at most 80° C., preferably at most 75° C., in particular at most 70° C. and especially at most 60° C. or at most 40° C., e.g. in the range from 0 to 80° C., in particular in the range from 5 to 75° C. or from 10 to 70° C. and especially in the range 10 to 60° C. or 10 to 40° C.

The comparatively low glass transition temperature is beneficial for the capability of the polymers to act as reaction partner for polyfunctional crosslinkers, as a low glass transition temperature is associated with an increased mobility/flexibility of the polymer chain. Therefore, a polymer having comparatively low glass transition temperature and relatively low molecular weight, such as the polymer P comprising the above-mentioned monomer unit M1.a, can better penetrate into wood or wooden material and more effectively undergo crosslinking reaction.

For better penetration into porous materials including wood or wooden materials, the polymer requires following properties: 1) a low molecular weight, 2) a low glass transition temperature in the range of 0 to 80° C., 3) a comparatively high acid number due to the amount of acid monomer such as the above mentioned monomer M2, 4) a alkaline pH value (a high neutralization grad of the polymer), and 5) a certain reactivity of the polymer.

The actual glass transition temperature depends on the monomer compositions forming the corresponding polymer and the theoretical glass transition temperature can be calculated from the monomer composition used in the polymerization. The theoretical glass transition temperatures are usually calculated from the monomer composition by the Fox equation:

$$1 / {Tg}^{t} = {x}_{a} / {Tg}_{a} + {x}_{b} / {Tg}_{b} + ... . {x}_{n} / {Tg}_{n} ,$$

In this equation xₐ, x_{b}, . . . xₙ are the mass fractions of the monomers a, b, . . . n and Tgₐ, Tg_{b}, . . . Tgₙ are the actual glass transition temperatures in Kelvin of the homopolymers synthesized from only one of the monomers a, b, c, . . . n at a time. The Fox equation is described by T. G. Fox in Bull. Am. Phys. Soc. 1956, 1, page 123 and as well as in Ullmann's Encyclopadie der technischen Chemie [Ullmann's Encyclopedia of Industrial Chemistry], vol. 19, p. 18, 4th ed., Verlag Chemie, Weinheim, 1980. The actual Tg values for the homopolymers of most monomers are known and listed, for example, in Ullmann's Encyclopädie der technischen Chemie [Ullmann's Encyclopedia of Industrial Chemistry], 5th ed., vol. A21, p. 169, Verlag Chemie, Weinheim, 1992. Further sources of glass transition temperatures of homopolymers are, for example, J. Brandrup, E. H. Immergut, Polymer Handbook, 1st Ed., J. Wiley, New York 1966, 2nd Ed. J. Wiley, New York 1975, 3rd Ed. J. Wiley, New York 1989 and 4th Ed. J. Wiley, New York 2004.

For the calculation of the theoretical glass transition temperature of the copolymers of the present invention by the Fox equation, glass transition temperatures of the homopolymers of the following monomers are assumed. This value is based on own calculations/extrapolations from experimental data, i.e. from the experimentally determined glass transition temperature of copolymers of said monomers with well analyzed co-monomers such as methyl methacrylate or n-butyl acrylate.

| | Tg | |
|---|---|---|
| | Homopolymer | |
| Monomer | [° C.] | Source |
| ethyl acrylate | −8 | Tsavalas¹ |
| n-butyl acrylate | −40 | Tsavalas |
| isobutyl acrylate | −24 | Aldrich² |
| n-butyl methacrylate | +35 | Tsavalas |
| 2-ethylhexyl acrylate | −60 | Tsavalas |
| 2-octyl acrylate | −45 | Polymer Handbook³ |
| cycohexyl methacrylate | +92 | Aldrich |
| methyl methacrylate | +119 | Tsavalas |
| styrene | +104 | Tsavalas |
| methacrylic acid | +185 | Tsavalas |
| diacetone acrylamide | +85 | supplier⁴ |
| 2-(acetylacetoxyethyl) | +8 | own DSC measurement |
| methacrylate | | on homopolymer |
| 2-(imidazolin-2-on-1-yl)ethyl | +10 | own DSC measurement |
| methacrylate (pure) | | on copolymer with |
| | | MMA⁵ |

¹Tsavalas et al. Langmuir 2010, 26(10), 6960-6966
²https://www3.nd.edu/~hgao/thermal_transitions_of_homopolymers.pdf
³Andrews, R. J. and Grulke, E. A. (2003). Glass Transition Temperatures of Polymers. In The Wiley Database of Polymer Properties (eds J. Brandrup, E. H. Immergut and E. A. Grulke)
⁴https://www.gantrade.com/blog/daam-vs-adh
⁵calculated using the Tg value of UMA-MMA-copolymer determined by DSC, wherein the copolymer consists of 50 wt. % of UMA and 50 wt. % of MMA with respect to the total weight of the copolymer.

Usually, the theoretical glass temperature Tg^{t} calculated according to Fox as described herein and the experimentally determined glass transition temperature as described herein are similar or even same and do not deviate from each other by more than 5 K, in particular they deviate not more than 2 K. Accordingly, both the actual and the theoretical glass transition temperatures of the polymer P can be adjusted by choosing proper monomers Ma, Mb . . . Mn and their mass fractions xₐ, x_{b}, . . . xₙ in the monomer composition so to arrive at the desired glass transition temperature. It is common knowledge for a skilled person to choose the proper amounts of monomers Ma, Mb . . . Mn for obtaining a polymer with the desired glass transition temperature.

The monomers M forming the polymer P of the present invention are selected such that the theoretical glass transition temperature according to Fox (Tg^{t}) of the polymer P is at most 80° C., preferably at most 60° C., more preferably at most 40° C., e.g., in the range from −40 to +80° C., in particular in the range from 0 to +60° C., especially in the range from 10 to +40° C.

The polymer P generally has a Young's modulus E in the range of 1 to 60, in particular in the range of 2 to 50, preferably in the range of 5 to 45, as determined by Dynamic Mechanical Thermal Analysis (DMTA).

The viscoelastic behaviour of polymers, especially elasticity of polymers, can be determined by Dynamic Mechanical Thermal Analysis (DMTA), also referred to as Dynamic Mechanical Analysis (DMA), as for example described by Urban et al. in Polymer Dispersions and Their Industrial Applications (Wiley-VCH ©2002), pages 63/64. For example, DMTA measurements can be carried out by recording the storage (E′) and loss moduli (E″) as function of the oscillation frequency or by measuring E′ and E″ a constant frequency over a temperature range. As a result of the time-temperature superposition principle, the temperature scan provides the same information as the frequency scan.

Elasticity of polymers is expressed by Young's modulus E, which is a mechanical property that measures the tensile or compressive stiffness of a solid material when the force is applied lengthwise. It quantifies the relationship between tensile/compressive stress σ (force per unit area) and axial strain ε (proportional deformation) in the linear elastic region of a material and is determined using the following formula.

$$E = \frac{σ}{ε}$$

Dynamic elastic modulus E* is calculated as follows:

$${E}^{*} = {E}^{′} + {iE}^{″}$$

wherein E′ is the so-called storage modulus, E″ the loss modulus and i=\sqrt{−1}. E′ is a measure of the (recoverable) energy stored in the film during deformation and E″ is the (irrecoverable) energy that is dissipated in the film as heat. Furthermore, a maximum in E″ corresponds to the glass-transition temperature T_{g} of the polymer/polymer phase being analyzed which is usually in good accordance with the T_{g} value determined by DSC.

A particular group of embodiments of the invention relates to the use of an aqueous polymer composition as defined herein, wherein at least some of the carbon atoms of the monomers M1 are of biological origin, i.e., they are at least partly made of biogenic carbon. In particular, aliphatic or cycloaliphatic alcohols used for the production of the alkyl and cycloalkylester monomers M1 preferably have a content of biogenic carbon of at least 90%, based on the total amount of carbon atoms in the respective alkanol, cycloalkanol or aliphatic carboxylic acid, respectively. This content is advantageously higher, in particular greater than or equal to 95%, preferably greater than or equal to 98% and advantageously equal to 100%. Similarly, acrylic acid may be produced from renewable materials. However, acrylic acid produced from biomaterials is not available on large scale so far.

Consequently, the monomers M1 have a content of biogenic carbon of preferably at least 40%, in particular at least 50% and especially at least 55%, based on the total amount of carbon atoms in the respective monomer. By using such monomers M1, which are at least partly of biological origin, the demand of fossil carbon in the polymer latex can be significantly reduced. In particular, the amount of carbon of biological origin of at least 10%, in particular at least 15% or at least 20% or higher, e.g., 30% or 40% or higher can be achieved. Examples of such monomers M1 with “biogenic carbons” are ethyl acrylate, isobutyl acrylate, 2-octyl acrylate, isobornyl acrylate, ethyl methacrylate, isobutyl methacrylate, 2-octyl methacrylate and isobornyl methacrylate.

The term “biogenic carbon” indicates that the carbon is of biological origin and comes from a biomaterial/renewable resources. The content in biogenic carbon and the content in biomaterial are expressions that indicate the same value. A material of renewable origin or biomaterial is an organic material wherein the carbon comes from the CO₂ fixed recently (on a human scale) by photosynthesis from the atmosphere. A biomaterial (Carbon of 100% natural origin) has an isotopic ratio ¹⁴C/¹²C greater than 10⁻¹², typically about 1.2×10⁻¹², while a fossil material has a zero ratio. Indeed, the isotopic ¹⁴C is formed in the atmosphere and is then integrated via photosynthesis, according to a time scale of a few tens of years at most. The half-life of the ¹⁴C is 5,730 years. Thus, the materials coming from photosynthesis, namely plants in general, necessarily have a maximum content in isotope ¹⁴C. The determination of the content of biomaterial or of biogenic carbon can be carried out in accordance with the standards ASTM D 6866-18, the method B (ASTM D 6866-06) and ASTM D 7026 (ASTM D 7026-04).

According to the invention, the aqueous polymer composition contains a water-soluble or water dispersible polymer P as described herein, wherein the polymer P is dissolved or dispersed in an aqueous phase such that the acid groups of the polymer P are totally or partially neutralized. In particular, the degree of neutralization is at least 70%, preferably in the range of 70 to 100%, based on the amount of acid groups in the polymer.

In a preferred embodiment of the invention, the polymers P are dispersed in an aqueous phase and present in the form of polymer particles. These polymer particles P in the aqueous phase typically have particle size distribution with mean value of less than 300 nm, in particular up to 150 nm, e.g., in the range of 30 to 150 nm, especially up to 80 nm, e.g., in the range of 30 to 80 nm, as determined at a temperature in the range of 20 to 25° C. by hydrodynamic chromatography fractionation (HDC) of an aqueous polymer dispersion of the polymer P with an aqueous eluent having a pH value in the range of 5.5 to 6.0. Furthermore, the polymer particles P frequently have a weight-average particle diameter of less than 290 nm, in particular up to 100 nm, especially up to 80 nm at pH in the range of 8.0 to 9.5.

The particle size distribution of the polymer particles P may be monomodal or almost monomodal, which means that the distribution function of the particle size has a single maximum and no particular shoulder. The particle size distribution of the polymer particles P may also be polymodal or almost polymodal, which means that the distribution function of the particle size has at least two distinct maxima or at last one maximum and at least a pronounced shoulder.

The weight-average particle diameter, which corresponds to the diameter of the sphere that has the same weight as a given particle, is determined by HDC (Hydrodynamic Chromatography fractionation), as for example described by H. Wiese, “Characterization of Aqueous Polymer Dispersions” in Polymer Dispersions and Their Industrial Applications (Wiley-VCH, 2002), pp. 41-73. For example, HDC measurements can be carried out using a PL-PSDA particle size distribution analyzer (Polymer Laboratories, Inc.), by injecting a small amount of sample into an aqueous eluent containing an emulsifier, resulting in a concentration of approx. 0.5 g/l and pumping the resulting mixture through a glass capillary tube of approx. 15 mm diameter packed with polystyrene spheres. As determined by their hydrodynamic diameter, smaller particles can sterically access regions of slower flow in capillaries, such that on average the smaller particles experience slower elution flow. The fractionation can be finally monitored using e.g., an UV-detector which measured the extinction at a fixed wavelength of 254 nm.

Determination of the average particle diameters as well as the particle size distribution may also be carried out by quasielastic light scattering (QELS), also known as dynamic light scattering (DLS). The measurement method is described in the ISO 13321:1996 standard. The determination can be carried out using a High-Performance Particle Sizer (HPPS). For this purpose, a sample of the aqueous polymer latex will be diluted and the dilution will be analyzed. In the context of QELS, the aqueous dilution may have a polymer concentration in the range from 0.001 to 0.5% by weight, depending on the particle size. For most purposes, a proper concentration will be 0.01% by weight. However, higher or lower concentrations may be used to achieve an optimum signal/noise ratio. The dilution can be achieved by addition of the polymer latex to water or an aqueous solution of a surfactant in order to avoid flocculation. Usually, dilution is performed by using a 0.1% by weight aqueous solution of a non-ionic emulsifier, e.g., an ethoxylated C16/C18 alkanol (degree of ethoxylation of 18), as a diluent. Measurement configuration: HPPS from Malvern, automated, with continuous-flow cuvette and Gilson autosampler. Parameters: measurement temperature 20.0° C.; measurement time 120 seconds (6 cycles each of 20 s); scattering angle 173°; wavelength laser 633 nm (HeNe); refractive index of medium 1.332 (aqueous); viscosity 0.9546 mPa·s. The measurement gives an average value of the second order cumulant analysis (mean of fits), i.e., Z average. The “mean of fits” is an average, intensity-weighted hydrodynamic particle diameter in nm.

Preferably, the polymer P has a weight-average molecular weight of at most 20 kDa, in particular in the range of 5 to 20 kDa, in particular in the range of 5 to 15 kDa, especially in the range of 5 to 10 kDa. The weight average molecular weight as referred to herein is typically determined by gel permeation chromatography (GPC) using polymethylmethacrylate standards and tetrahydrofurane as liquid phase.

The solids content of the aqueous polymer composition containing the polymer P is usually in the range of 10 to 45% by weight, particularly preferably 15 to 40% by weight, even more preferably 20 to 30% by weight, based on the total amount of liquid components of the aqueous polymer composition.

The polymer P is generally obtained by a process comprising a free radical polymerization of the monomers M as described herein in an aqueous reaction medium. The free radical polymerization of the process for preparing the polymer P is usually carried out by an aqueous emulsion polymerization of the monomers M.

The term free radical polymerization is understood that the polymerization of the monomer composition is performed in the presence of a polymerization initiator, which, under polymerization conditions, forms radicals, either be thermal decomposition or by a redox reaction. A skilled person is conversant with free radical polymerizations which are well described in the art, e.g. in “Polymer Chemistry” by S. Koltzenburg, M. Maskos, O. Nuyken (Springer-Verlag 2017) and literature cited therein. Principally, the process can be conducted by analogy to the process described in WO 2015/197662.

An emulsion polymerization is a type of radical polymerization that usually starts with an emulsion incorporating water, monomer, and surfactant. In an aqueous emulsion polymerization, droplets of monomer are emulsified (with surfactants) in a continuous phase of water.

The conditions required for the performance of the emulsion polymerization of the monomers M are sufficiently familiar to those skilled in the art, for example from the prior art cited at the outset and from “Emulsionspolymerisation” [Emulsion Polymerization] in Encyclopedia of Polymer Science and Engineering, vol. 8, pages 659 ﬀ. (1987); D. C. Blackley, in High Polymer Latices, vol. 1, pages 35 ﬀ. (1966); H. Warson, The Applications of Synthetic Resin Emulsions, chapter 5, pages 246 ﬀ. (1972); D. Diederich, Chemie in unserer Zeit 24, pages 135 to 142 (1990); Emulsion Polymerisation, Interscience Publishers, New York (1965); DE 4003422 A and Dispersionen synthetischer Hochpolymerer [Dispersions of Synthetic High Polymers], F. Hölscher, Springer-Verlag, Berlin (1969)], EP 184091, EP 710680, WO 2012/130712 and WO 2016/04116.

The free-radically initiated aqueous emulsion polymerization is triggered by means of a free-radical polymerization initiator (free-radical initiator). These may, in principle, be peroxides or azo compounds. Of course, redox initiator systems are also useful. Peroxides used may, in principle, be inorganic peroxides, such as hydrogen peroxide or peroxodisulfates, such as the mono- or di-alkali metal or ammonium salts of peroxodisulfuric acid, for example the mono- and disodium, -potassium or ammonium salts, or organic peroxides such as alkyl hydroperoxides, for example tert-butyl hydroperoxide, p-menthyl hydroperoxide or cumyl hydroperoxide, and also dialkyl or diaryl peroxides, such as di-tert-butyl or di-cumyl peroxide. Azo compounds used are essentially 2,2′-azobis (isobutyronitrile), 2,2′-azobis (2,4-dimethylvaleronitrile) and 2,2′-azobis (amidinopropyl) dihydrochloride (AIBA, corresponds to V-50 from Wako Chemicals). Suitable oxidizing agents for redox initiator systems are essentially the peroxides specified above. Corresponding reducing agents which may be used are sulfur compounds with a low oxidation state, such as alkali metal sulfites, for example potassium and/or sodium sulfite, alkali metal hydrogensulfites, for example potassium and/or sodium hydrogensulfite, alkali metal metabisulfites, for example potassium and/or sodium metabisulfite, formaldehydesulfoxylates, for example potassium and/or sodium formaldehydesulfoxylate, alkali metal salts, specifically potassium and/or sodium salts of aliphatic sulfinic acids and alkali metal hydrogensulfides, for example potassium and/or sodium hydrogensulfide, salts of polyvalent metals, such as iron (II) sulfate, iron (II) ammonium sulfate, iron (II) phosphate, ene diols, such as dihydroxymaleic acid, benzoin and/or ascorbic acid, and reducing saccharides, such as sorbose, glucose, fructose and/or dihydroxyacetone.

Preferred free-radical initiators are inorganic peroxides, especially peroxodisulfates, and redox initiator systems, in particular ammonium peroxodisulfate.

In general, the amount of the free-radical initiator used, based on the total amount of monomers M, is 0.01 to 5 pphm, preferably 0.1 to 3 pphm.

The amount of free-radical initiator required for the emulsion polymerization of monomers M can be initially charged in the polymerization vessel completely. However, it is also possible to charge none of or merely a portion of the free-radical initiator, for example not more than 30% by weight, especially not more than 20% by weight, based on the total amount of the free-radical initiator and then to add any remaining amount of free-radical initiator to the free-radical polymerization reaction under polymerization conditions. Preferably, at least 70%, in particular at least 80%, especially at least 90% or the total amount of the polymerization initiator are fed to the free-radical polymerization reaction under polymerization conditions. Feeding of the monomers M may be done according to the consumption, batch-wise in one or more portions or continuously with constant or varying flow rates during the free-radical emulsion polymerization of the monomers M.

The emulsion polymerization can be started with water-soluble initiators. Water-soluble initiators include ammonium and alkali metal salts of peroxodisulfuric acid, e.g., sodium peroxodisulfate, hydrogen peroxide or organic peroxides, e.g., tert-butyl hydroperoxide. Also suitable as initiators are so-called reduction-oxidation (Red-Ox) initiator systems. Red-Ox initiator systems consist of at least one mostly inorganic reducing agent and an inorganic or organic oxidizing agent. The oxidizing agent is, for example, the initiators for emulsion polymerization already mentioned above. The reducing agent is, for example, alkali metal salts of sulfurous acid, such as sodium sulfite, sodium hydrogen sulfite, alkali salts of dimethyl sulfite, such as sodium disulfite, bisulfite addition compounds of aliphatic aldehydes and ketones, such as acetone bisulfite, or reducing agents such as hydroxymethanesulfinic acid and salts thereof, or ascorbic acid. The Red-Ox initiator systems can be used with the co-application of soluble metal compounds, whose metallic component can occur in several valence states. Common RedOx initiator systems include ascorbic acid/iron (II) sulfate/sodium peroxide disulfate, tert-butyl hydroperoxide/sodium disulfite, tert-butyl hydroperoxide/Na-hydroxymethanesulfinic acid. The individual components, e.g., the reduction component, can also be mixtures, e.g., a mixture of the sodium salt of hydroxymethanesulfinic acid and sodium disulfite.

The initiators can be used in the form of aqueous solutions, wherein the lower concentration is determined by the amount of water that can be used in the aqueous polymer composition and the upper concentration is determined by the solubility of the compound in question in water. In general, the concentration of the initiators is 0.1 to 30% by weight, preferably 0.2 to 20% by weight, particularly preferably 0.3 to 10% by weight, based on the weight of the monomers to be polymerized. Several different initiators can also be used in emulsion polymerization.

Generally, the term “polymerization conditions” is understood to mean those temperatures and pressures under which the free-radically initiated aqueous emulsion polymerization proceeds at sufficient polymerization rate. They depend particularly on the free-radical initiator used. Advantageously, the type and amount of the free-radical initiator, polymerization temperature and polymerization pressure are selected, such that a sufficient amount of initiating radicals is always present to initiate or to maintain the polymerization reaction.

Preferably, the radical emulsion polymerization of the monomers M is performed by a so-called feed process (also termed monomer feed method), which means that at least 80%, in particular at least 90% or the total amount of the monomers M to be polymerized are metered to the polymerization reaction under polymerization conditions during a metering period P. Addition may be done in portions and preferably continuously with constant or varying feed rate. The duration of the period may depend on the production equipment and may vary from e.g. 20 minutes to 12 h. Frequently, the duration of the period will be in the range from 0.5 h to 8 h, especially from 1 h to 6 h. Preferably, at least 70%, in particular at least 80%, especially at least 90% or the total amount of the polymerization initiator is introduced into emulsion polymerization in parallel to the addition of the monomers.

The free-radical aqueous emulsion polymerization of the invention is usually conducted at temperatures in the range from 0 to +170° C. Temperatures employed are frequently in the range from +50 to +120° C., in particular in the range from +60 to +120° C. and especially in the range from +70 to +110° C.

The free-radical aqueous emulsion polymerization of the invention can be conducted at a pressure of less than, equal to or greater than 1 atm (atmospheric pressure), and so the polymerization temperature may exceed +100° C. and may be up to +170° C. Polymerization of the monomers is normally performed at ambient pressure, but it may also be performed under elevated pressure. In this case, the pressure may assume values of 1.2, 1.5, 2, 5, 10, 15 bar (absolute) or even higher values. If emulsion polymerizations are conducted under reduced pressure, pressures of 950 mbar, frequently of 900 mbar and often 850 mbar (absolute) are established. Advantageously, the free-radical aqueous emulsion polymerization of the invention is conducted at ambient pressure (about 1 atm) with exclusion of oxygen, for example under an inert gas atmosphere, for example under nitrogen or argon.

The aqueous radical emulsion polymerization is usually performed in the presence of one or more suitable surfactants. These surfactants typically comprise emulsifiers and provide micelles, in which the polymerization occurs, and which serve to stabilize the monomer droplets during aqueous emulsion polymerization and also growing polymer particles. The surfactants used in the emulsion polymerization are usually not separated from the polymer P, but remain in the polymer P obtainable by the emulsion polymerization of the monomers M.

The surfactant may be selected from emulsifiers and protective colloids. Protective colloids, as opposed to emulsifiers, are understood to mean polymeric compounds having molecular weights above 2000 Daltons, whereas emulsifiers typically have lower molecular weights. The surfactants may be anionic or non-ionic or mixtures of non-ionic and anionic surfactants.

Preferably, the emulsion polymerization of the monomers M is carried out in the presence of at least one anionic copolymerizable emulsifier. Preferably, the amount of anionic copolymerizable emulsifier is in the range of 1 to 10% by weight, in particular in the range of 2 to 8% by weight, especially in the range of 3 to 6% by weight, based on the solids content of the finished aqueous polymer latex.

Anionic surfactants usually bear at least one anionic group which is typically selected from phosphate, phosphonate, sulfate and sulfonate groups. The anionic surfactants which bear at least one anionic group are typically used in the form of their alkali metal salts, especially of their sodium salts or in the form of their ammonium salts.

Preferred anionic surfactants are anionic emulsifiers, in particular those which bear at least one sulfate or sulfonate group. Likewise, anionic emulsifiers which bear at least one phosphate or phosphonate group may be used, either as sole anionic emulsifiers or in combination with one or more anionic emulsifiers which bear at least one sulfate or sulfonate group.

Examples of anionic emulsifiers which bear at least one sulfate or sulfonate group, are, for example,
the salts, especially the alkali metal and ammonium salts, of alkyl sulfates, especially of C₈-C₂₂-alkyl sulfates,
the salts, especially the alkali metal and ammonium salts, of sulfuric monoesters of ethoxylated alkanols, especially of sulfuric monoesters of ethoxylated C₈-C₂₂-alkanols, preferably having an ethoxylation level (EO level) in the range from 2 to 40,
the salts, especially the alkali metal and ammonium salts, of alkylsulfonic acids, especially of C₈-C₂₂-alkylsulfonic acids,
the salts, especially the alkali metal and ammonium salts, of dialkyl esters, especially di-C₄-C₁₈-alkyl esters of sulfosuccinic acid,
the salts, especially the alkali metal and ammonium salts, of alkylbenzenesulfonic acids, especially of C₄-C₂₂-alkylbenzenesulfonic acids, and
the salts, especially the alkali metal and ammonium salts, of mono- or disulfonated, alkyl-substituted diphenyl ethers, for example of bis(phenylsulfonic acid) ethers bearing a C₄-C₂₄-alkyl group on one or both aromatic rings. The latter are common knowledge, for example from U.S. Pat. No. 4,269,749, and are commercially available, for example as Dowfax® 2A1 (Dow Chemical Company),
surfactants, which have a polymerizable ethylenically unsaturated double bond as described herein, e.g., the compounds of the formulae (I)-(IV), where X and Y, respectively, are SO₃⁻ or O—SO₃⁻.

Examples of anionic emulsifiers, which bear a phosphate or phosphonate group, include, but are not limited to the following salts are selected from the following groups:
the salts, especially the alkali metal and ammonium salts, of mono- and dialkyl phosphates, especially C₈-C₂₂-alkyl phosphates,
the salts, especially the alkali metal and ammonium salts, of phosphoric monoesters of C₂-C₃-alkoxylated alkanols, preferably having an alkoxylation level in the range from 2 to 40, especially in the range from 3 to 30, for example phosphoric monoesters of ethoxylated C₈-C₂₂-alkanols, preferably having an ethoxylation level (EO level) in the range from 2 to 40, phosphoric monoesters of propoxylated C₈-C₂₂-alkanols, preferably having a propoxylation level (PO level) in the range from 2 to 40, and phosphoric monoesters of ethoxylated-co-propoxylated C₈-C₂₂-alkanols, preferably having an ethoxylation level (EO level) in the range from 1 to 20 and a propoxylation level of 1 to 20,
the salts, especially the alkali metal and ammonium salts, of alkylphosphonic acids, especially C₈-C₂₂-alkylphosphonic acids and
the salts, especially the alkali metal and ammonium salts, of alkylbenzenephosphonic acids, especially C₄-C₂₂-alkylbenzenephosphonic acids.
surfactants, which have a polymerizable ethylenically unsaturated double bond as described herein, e.g., the compounds of the formulae (I)-(IV), where X and Y, respectively, are HPO₃⁻, PO₃²⁻, O—HPO₃⁻; or O—PO₃²⁻.

Anionic emulsifiers may also comprise emulsifiers, which have a polymerizable double bond, e.g., the emulsifiers of the formulae (I) to (IV) and the salts thereof, in particular the alkalimetal salts or ammonium salts thereof:

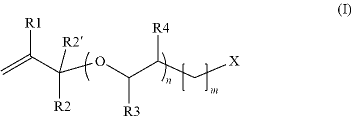

In formula (I), R¹ is H, C₁-C₂₀-alkyl, C₅-C₁₀-cycloalkyl, phenyl optionally substituted with C₁-C₂₀-alkyl, R² and R²′ are both —H, each, or together are ═O, R³ and R⁴ are H or methyl, m is 0 or 1, n is an integer from 1-100 and X is SO₃⁻, O—SO₃⁻, O—HPO₃⁻ or O—PO₃²⁻.

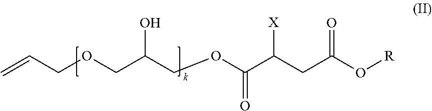

In formula (II), R is H, C₁-C₂₀-alkyl, C₅-C₁₀-cycloalkyl, phenyl optionally substituted with C₁-C₂₀-alkyl, k is 0 or 1 and X is SO₃⁻, O—SO₃⁻, O—HPO₃⁻ or O—PO₃²⁻.

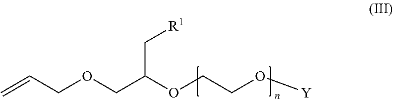

In formula (III), R¹ is H, OH, C₁-C₂₀-alkyl, O—C₁-C₂₀-alkyl, C₅-C₁₀-cycloalkyl, O—C₅-C₁₀-cycloalkyl, O-phenyl optionally substituted with C₁-C₂₀-alkyl, n is an integer from 1-100 and Y is SO₃⁻, HPO₃⁻ or PO₃²⁻.

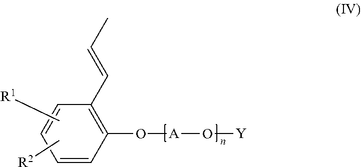

In formula (IV), R¹ is H, C₁-C₂₀-alkyl or 1-phenylethyl, R² is H, C₁-C₂₀-alkyl or 1-phenylethyl, A is C₂-C₄-alkandiyl, such as 1,2-ethandiyl or 1,2-propandiyl or combinations thereof, n is an integer from 1-100 and Y is SO₃⁻, HPO₃⁻ or PO₃²⁻.

The anionic copolymerizable emulsifiers may be present in neutralized form. Preferably, as counterion for the anionic groups X and/or Y, there is a cation selected from the group consisting of H⁺, Li⁺, Na⁺, K⁺, Ca²⁺, NH₄⁺ and mixtures thereof. Preferred cations are NH₄⁺ or Na⁺.

Particular embodiments of the copolymerizable emulsifiers of the formula (I) are referred to as sulfate esters or phosphate esters of polyethylene glycol monoacrylates. Particular embodiments of the copolymerizable emulsifiers of the formula (I) may likewise also be referred to as phosphonate esters of polyethylene glycol monoacrylates, or allyl ether sulfates. Commercially available copolymerizable emulsifiers of the formula (I) are Maxemul® emulsifiers, Sipomer® PAM emulsifiers, Latemul® PD, and ADEKA Reasoap® PP-70.

Particular embodiments of the copolymerizable emulsifiers of the formula (II) are also referred to as alkyl allyl sulfosuccinates. Commercially available copolymerizable emulsifiers of the formula (II) is Trem® LF40.

Particular embodiments of the copolymerizable emulsifiers of the formula (III) are also referred to as branched unsaturated. Commercially available copolymerizable emulsifiers of the formula (III) are Adeka® Reasoap emulsifiers and Hitenol® KH.

Particular embodiments of the copolymerizable emulsifiers of the formula (IV) are also referred to as polyoxyethylene alkylphenyl ether sulfate and polyoxyethylene mono-or distyrylphenyl ether sulfate. Commercially available copolymerizable emulsifiers of the formula (IV) are Hitenol® BC and Hitenol® AR emulsifiers.

Further suitable anionic surfactants can be found in Houben-Weyl, Methoden der organischen Chemie [Methods of Organic Chemistry], volume XIV/1,

Makromolekulare Stoffe [Macromolecular Substances], Georg-Thieme-Verlag, Stuttgart, 1961, p. 192-208.

Preferably, the surfactant comprises at least one anionic emulsifier which bears at least one sulfate or sulfonate group. The at least one anionic emulsifier which bears at least one sulfate or sulfonate group, may be the sole type of anionic emulsifiers. However, mixtures of at least one anionic emulsifier, which bears at least one sulfate or sulfonate group and at least one anionic emulsifier which bears at least one phosphate or phosphonate group may also be used. In such mixtures, the amount of the at least one anionic emulsifier which bears at least one sulfate or sulfonate group is preferably at least 50% by weight, based on the total weight of anionic surfactants used in the process of the present invention. In particular, the amount of anionic emulsifiers which bear at least one phosphate or phosphonate group does not exceed 20% by weight, based on the total weight of anionic surfactants used in the process of the present invention.

Preferred anionic surfactants are anionic emulsifiers, which are selected from the following groups, including mixtures thereof:
the salts, especially the alkali metal and ammonium salts, of alkyl sulfates, especially of C₈-C₂₂-alkyl sulfates,
the salts, especially the alkali metal salts, of sulfuric monoesters of ethoxylated alkanols, especially of sulfuric monoesters of ethoxylated C₈-C₂₂-alkanols, preferably having an ethoxylation level (EO level) in the range from 2 to 40,
of sulfuric monoesters of ethoxylated alkylphenols, especially of sulfuric monoesters of ethoxylated C₄-C₁₈-alkylphenols (EO level preferably 3 to 40),
of alkylbenzenesulfonic acids, especially of C₄-C₂₂-alkylbenzenesulfonic acids, and
of mono- or disulfonated, alkyl-substituted diphenyl ethers, for example of bis(phenylsulfonic acid) ethers bearing a C₄-C₂₄-alkyl group on one or both aromatic rings.
polymerizable emulsifiers of the formula (III).

Particular preference is given to anionic emulsifiers, which are selected from the following groups including mixtures thereof:
the salts, especially the alkali metal and ammonium salts, of alkyl sulfates, especially of C₈-C₂₂-alkyl sulfates,
the salts, especially the alkali metal salts, of sulfuric monoesters of ethoxylated alkanols, especially of sulfuric monoesters of ethoxylated C₈-C₂₂-alkanols, preferably having an ethoxylation level (EO level) in the range from 2 to 40,
of mono- or disulfonated, alkyl-substituted diphenyl ethers, for example of bis(phenylsulfonic acid) ethers bearing a C₄-C₂₄-alkyl group on one or both aromatic rings
polymerizable emulsifiers of the formula (III), where Y is SO₃⁻.

Preferably, the polymer P obtained by a process of a free radical emulsion polymerization, as described above, is mixed with a base. The base leads to a partial or complete neutralization of the acidic groups of the polymer P. It can lead to a swelling of the polymer particles of the polymer P obtained by emulsion polymerization of the monomers M, but can also completely transfer them into solution. Preferably, only partial neutralization is carried out, for example at least 70%, particularly at least 60%, more particularly at least 50% of the acid groups present.

The neutralization of the acid groups of the polymer P can be carried out, in particular by at least partial addition of a base after and/or during the polymerization. The base can be added in a common feed with the monomers to be polymerized or in a separate feed, in particular after the polymerization. The base required for neutralization of at least 70%, preferably 70 to 100% or 70 to 95% acid equivalents is contained in the polymerization vessel. Preferably, at least 70%, in particular at least 90% or the total amount of the base required for neutralization of the acid groups in the polymer P made of the monomers M is added after the polymerization of the monomers M is completed.

Examples of suitable bases for neutralization of the acid groups of the polymer P made of the monomers M include, but are not limited to alkali or alkaline earth compounds such as sodium hydroxide, potassium hydroxide, calcium hydroxide, magnesium oxide, sodium carbonate; ammonia; primary, secondary and tertiary amines, such as ethylamine, propylamine, monoisopropylamine, monobutylamine, hexylamine, ethanolamine, dimethylamine, diethylamine, din-propylamine, tributylamine, triethanolamine, dimethoxyethylamine, 2-ethoxyethylamine, 3-ethoxypropylamine, dimethylethanolamine, diisopropanolamine, morpholine, ethylenediamine, 2-diethylaminethylamine, 2,3-diaminopropane, 1,2-propylenediamine, dimethylaminopropylamine, neopentanediamine, hexamethylenediamine, 4,9-dioxadodecane-1,12-diamine, polyethyleneimine or polyvinylamine. Preferably, the base used for neutralization is a volatile base, more preferably ammonia.

In particular, the polymer P is obtainable by the polymerization of the monomers M in the presence of at least one chain transfer agent.

In general, chain transfer agents are understood to mean compounds that transfer free radicals, thereby stop the growth of the polymer chain or control chain growth in the polymerization, and which thus reduce the molecular weight of the resulting polymers. Usually, chain transfer agents possess at least one readily abstractable hydrogen atom. Preferably, the abstractable hydrogen is part of a mercapto group, i.e. a group SH, also termed “thiol group”.

The chain transfer agent is in particular selected from the group consisting of
C₁-C₂₀-alkyl esters of SH-substituted C₂-C₆ alkanoic acids, hereinafter C₂-C₆ thioalkanoic acids (chain transfer compounds T.1), in particular C₁-C₂₀-alkyl esters of mercaptoacetic acid (=thioglycolic acid)), such as methyl thioglycolate, ethyl thioglycolate, n-butyl thioglycolate, n-hexyl thioglycolate, n-octyl thioglycolate, 2-ethylhexyl thioglycolate, isooctyl thioglycolate and n-decylthioglycolate, and C₁-C₂₀-alkyl esters of mercaptopropionic acid, such as methyl mercaptopropionate, ethyl mercaptopropionate, n-butyl mercaptopropionate, n-hexyl mercaptopropionate, n-octyl mercaptopropionate, 2-ethylhexyl mercaptopropionate, isooctyl mercaptopropionate and n-decyl mercaptopropionate;
C₁-C₂₀-alkyl mercaptans (chain transfer compounds T.2), in particular to C₆-C₁₆-alkyl mercaptans, for example ethanethiol, n-propanethiol, 2-propanethiol, n-butanethiol, 2-butanethiol, 2-methyl-2-propanethiol, n-pentanethiol, 2-pentanethiol, 3-pentanethiol, 2-methyl-2-butanethiol, 3-methyl-2-butanethiol, n-hexanethiol, 2-hexanethiol, 3-hexanethiol, 2-methyl-2-pentanethiol, 3-methyl-2-pentanethiol, 4-methyl-2-pentanethiol, 2-methyl-3-pentanethiol, 3-methyl-3-pentanethiol, 2-ethylbutanethiol, 2-ethyl-2-butanethiol, n-heptanethiol and the isomeric compounds thereof, n-octanethiol and the isomeric compounds thereof, n-nonanethiol and the isomeric compounds thereof, n-decanethiol and the isomeric compounds thereof, n-undecanethiol and the isomeric compounds thereof, n-dodecanethiol and the isomeric compounds thereof, such as tert.-dodecanethiol, n-tridecanethiol and isomeric compounds thereof;
OH-substituted C₂-C₂₀-alkyl mercaptans (chain transfer compounds T.3), for example 2-hydroxyethanethiol and 2-hydroxypropanethiol;
aromatic thiols (chain transfer compounds T.4), such as benzenethiol, ortho-, meta-or para-methylbenzenethiol,
and mixtures thereof.

Examples of further chain transfer agents, which may be used instead of the chain transfer agents T.1 to T.4 or in combination therewith are aliphatic and/or araliphatic halogen compounds, for example n-butyl chloride, n-butyl bromide, n-butyl iodide, methylene chloride, ethylene dichloride, chloroform, bromoform, bromotrichloromethane, dibromodichloromethane, carbon tetrachloride, carbon tetrabromide, benzyl chloride, benzyl bromide, but also aliphatic and/or aromatic aldehydes, such as acetaldehyde, propionaldehyde and/or benzaldehyde, hydrocarbons having readily abstractable hydrogen atoms, for example toluene and thiol compounds different from T.1 to T.4, e.g. thiol compounds described in Polymer Handbook, 3rd edition, 1989, J. Brandrup and E. H. Immergut, John Wiley & Sons, section II, pages 133 to 141.

Particular preference is given to chain transfer agents T.1 and T2, in particular to C₄-C₁₆-alkyl esters of SH-substituted C₂-C₄ alkanoic acids, especially to C₄-C₁₆-alkyl esters of mercaptoacetic acid, to C₄-C₁₆-alkyl esters of mercaptopropionic acid, to C₆-C₁₆-alkyl mercaptans and to mixtures thereof.

Especially preferred chain transfer agents are 3-mercapto-propionic acid isooctyl ester which is also termed isooctyl 3-mercaptopropionate (IOMPA), 2-ethylhexyl thioglycolate (EHTG) and tert.-dodecanethiol which is also termed tert-dodecyl mercaptane (tDMK).

The amount of chain transfer agent is preferably in the range of 0.15 to 15% by weight, in particular in the range from 2 to 10% by weight, especially in the range from 4 to 8% by weight, based on the total weight of the monomers M.

It is frequently advantageous when the aqueous polymer latex obtained on completion of polymerization of the monomers M is subjected to a post-treatment to reduce the residual monomer content. This post-treatment is carried out either chemically, for example by completing the polymerization reaction using a more effective free-radical initiator system (known as post-polymerization), and/or physically, for example by stripping the aqueous polymer latex with steam or inert gas. Corresponding chemical and physical methods are familiar to those skilled in the art, for example from EP 771328 A, DE 19624299 A, DE 19621027 A, DE 19741184 A, DE 19741187 A, DE 19805122 A, DE 19828183 A, DE 19839199 A, DE 19840586 A and DE 19847115 A. The combination of chemical and physical post-treatment has the advantage that it removes not only the unconverted ethylenically unsaturated monomers, but also other disruptive volatile organic constituents (VOCs) from the aqueous polymer latex.

Furthermore, in a preferred embodiment, the polymer P is subject to a post crosslinking reaction by a post crosslinking agent or by itself. Ideally, such a post-crosslinking agent will result in a crosslinking reaction during and/or after film formation by forming coordinative or covalent bonds with reactive sites on the surface of the polymer particles of the polymer P, more precisely, with the reactive functional group of the polymerized monomer M3 of the polymer particles of the polymer P. Such crosslinking is also known as chemical crosslinking.

Therefore, in a particular preferred embodiment, the aqueous polymer composition further comprises a crosslinking agent having at least two functional groups which are capable of forming a covalent bond with the reactive functional group of the polymerized monomer M3.

Crosslinking agents, which are suitable for providing post-crosslinking, are for example compounds having at least two functional groups selected from oxazoline, amino, aldehyde, aminoxy, carbodiimide, aziridinyl, epoxy and hydrazide groups, derivatives or compounds bearing acetoacetyl groups. These crosslinkers react with reactive sites of the polymer P, which bear complementary functional groups in the polymer, which are capable of forming a covalent bond with the crosslinker. Suitable systems are known to skilled persons.

As the polymer P of the invention bear acid groups such as carboxyl groups, post-crosslinking can be achieved by reacting the polymer P with one or more polycarbodiimides as described in U.S. Pat. Nos. 4,977,219, 5,047,588, 5,117,059, EP 0277361, EP 0507407, EP 0628582, U.S. Pat. No. 5,352,400, US 2011/0151128 and US 2011/0217471. It is assumed that crosslinking is based on the reaction of the carboxyl groups of the polymers with polycarbodiimides. The reaction typically results in covalent cross-links, which are predominately based on N-acyl urea bounds (J. W. Taylor and D. R. Bassett, in E. J. Glass (Ed.), Technology for Waterborne Coatings, ACS Symposium Series 663, Am. Chem. Soc., Washington, D C, 1997, chapter 8, pages 137 to 163).

Likewise, as the polymer particles of the polymer P of the present invention bear acid groups such as carboxyl groups stemming from the second monomers M2, a suitable post-crosslinking agent may also be a water-soluble or water-dispersible polymer bearing oxazoline groups, e.g., the polymers as described in U.S. Pat. No. 5,300,602 and WO 2015/197662.

Post-crosslinking can also be achieved by analogy to EP 1227116, which describes aqueous two-component coating compositions containing a binder polymer with carboxylic acid and hydroxyl functional groups and a polyfunctional crosslinker having functional groups selected from isocyanate, carbodiimide, aziridinyl and epoxy groups.

If the polymer P bears a keto group, e.g., by using a monomer such as diacetone acrylamide (DAAM), post-crosslinking can be achieved by formulating the aqueous polymer latex with one or more dihydrazides, in particular aliphatic dicarboxylic acid dihydrazides such as adipic acid dihydrazide (ADDH) as described in U.S. Pat. No. 4,931,494, US 2006/247367 and US 2004/143058. These components react basically during and after film formation, although a certain extent of preliminary reaction can occur.

In a preferred group of embodiments, the crosslinking agent is selected from aliphatic dicarboxylic acid dihydrazides, such as adipic acid dihydrazide (ADDH) and/or polyamines, such as low molecular weight diamines, polyetheramines and polyaziridines.

Here and throughout the term “low molecular weight” refers to molecular weight less than or equal to 700 Da.

In one embodiment, the crosslinking agent is selected from polyamines, such as low molecular weight diamines e.g. 1,6-hexamethylene diamine, 1,2-propanediamine, isophorone diamine, 1,3-diaminopentane, 4,7,10-trioxatridecan-1,13-diamine, 1,4-bisaminoxyl-butane, also including low molecular weight polyetheramines e.g. polyoxypropylenetriamine, polyoxypropylenediamine, polyetheramine of formula X,

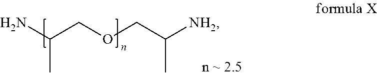

polyetheramine of formula Y,

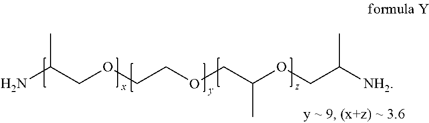

1,3-Diaminopentane, polyoxypropylenetriamine, polyoxypropylenediamine, polyetheramine of formula X and polyetheramine of formula Y are commercially available as Dytek® EP, Jeffamine® T-403, Polyetheramine® T403, Baxxodur® EC 310, Jeffamine® D-400, Polyetheramine® D400, Baxxodur® EC 302, Jeffamine® D-230, Polyetheramine® D230, Baxxodur® EC 301, and Jeffamine® ED-600, respectively.

In other embodiment, the crosslinking agent is selected from polyaziridines e.g. branched polyethylenimine having preferably number average molecular weight in the range of more than 250 to 2500 Da, which is commercially available as Lupasol® FG, Lupasol® G20 and Lupasol® G35, respectively.

In a more preferred group of embodiments, the monomer M3 composing the polymer P is a monomer M3.b.1) and the crosslinking agent is selected from aliphatic dicarboxylic acid dihydrazides, such as adipic acid dihydrazide (ADDH) or the monomer M3 is a monomer M3.b.2) and the crosslinking agent is selected from polyamines, such as polyetheramines and polyaziridines.

Other suitable agents of achieving post-curing include
epoxysilanes to crosslink carboxy groups in the polymer;
dialdehydes such as glyoxal to crosslink urea groups or acetoacetoxy groups, such as those derived from the monomers M1d as defined herein, in particular ureido (meth)acrylate, acetoacetoxyethyl acrylate or acetoacetoxyethyl methacrylate; and
di- and/or polyamines to crosslink keto groups or epoxy groups such as those derived from the monomers M1c or M1d as defined herein.

Suitable systems are e.g., described in EP 0789724, U.S. Pat. Nos. 5,516,453 and 5,498,659.

Beside chemical (post-) crosslinking, post-crosslinking can also be achieved by week interactions such as ionic bonds or hydrogen bonds. Such crosslinking is also known as physical crosslinking and does not involve crosslinking agents and forming of covalent bonds with the reactive functional group of the polymer. Suitable systems and methods in this regard are known to skilled persons, for example from Akhtar et al. Methods of synthesis of hydrogels . . . A review, Saudi Pharmaceutical Journal, Volume 24, Issue 5, 2016, pages 554-559.

It is known to those skilled in the art that post-crosslinking can also be achieved by self-crosslinking, for example, as described in U.S. Pat. No. 5,869,589A, which describes a self-crosslinking polymer composition comprising a free glyoxal crosslinker component and a vinyl polymer component made of polymerized at least one copolymerizable α, β-ethylenically unsaturated monomer.

In addition to the polymer, the crosslinking agent, the optional emulsifier, the optional base and water, the aqueous polymer composition as described herein may contain one or more additives conventionally used in stain compositions such as thickener, biocide, solvent, binder, dye or pigment.

### EXAMPLES

The invention is elucidated in more detail by the examples hereinafter.

### 1. Analytics of the Aqueous Polymer Composition

### 1.1 Particle Diameter (Particle Size)

The weight-average particle diameter of the polymer P in the aqueous phase was determined by HDC (Hydrodynamic Chromatography fractionation), as described above. Measurements were carried out using a PL-PSDA particle size distribution analyzer (Polymer Laboratories, Inc.). A small amount of sample of the polymer P in the aqueous phase was injected into an aqueous eluent containing an emulsifier, resulting in a concentration of approximately 0.5 g/l. The mixture was pumped through a glass capillary tube of approximately 15 mm diameter packed with polystyrene spheres. As determined by their hydrodynamic diameter, smaller particles can sterically access regions of slower flow in capillaries, such that on average the smaller particles experience slower elution flow. The fractionation was finally monitored using an UV-detector which measured the extinction at a fixed wavelength of 254 nm.

The average particle diameter of the polymer P in the aqueous phase may also be determined by dynamic light scattering (DLS) as described above, using a Malvern HPPS.

### 1.2 Glass Transition Temperature

The glass transition temperatures were determined by theoretical calculation by Fox equation (John Wiley & Sons Ltd., Baffins Lane, Chichester, England, 1997), as described above.

### 1.3 Molecular Weight of the Polymers

Molecular weight (M) of the polymer P in the aqueous phase was determined by gel permeation chromatography (GPC).

The GPC measurement was carried out with a GPC instrument including a detector (DRI Agilent 1100 UV Agilent 1100 VWD [254 nm]). A mixture of tetrahydrofuran (THF) and 0.1% trifluoroacetic acid was used as eluent and the flow rate was 1 mL/min. PLgel 10 μm was used as separation columns (separation range: 500-10,000,000 g/mol). The column temperature was 35° C. The system was calibrated with polystyrene standards (Fa. Polymer Laboratories) with a molecular weight in the range of 580 to 6,870,000 g/mol. The values outside this range were extrapolated. The evaluation had to be aborted after 26.757 mL corresponding to ca. M=744 g/mol as for lower molar mass than this, the resulting chromatogram was disturbed by impurities in the sample or the GPC eluent.

### 1.4 Degree of Neutralization

The degree of neutralization was calculated from the relative molar amount of acid used in the emulsion polymerization and the amount of base used for neutralization.

### 1.5 Solids Content

The solids content was determined by drying a defined amount of the aqueous polymer dispersion (about 2 g) to constant weight in an aluminum crucible having an internal diameter of about 5 cm at 130° C. in a drying cabinet (2 hours). Two separate measurements were conducted. The value reported in the example is the mean of the two measurements.

### 1.6 Light Transmittance

Light transmittance (LD100 value) of the modified polymer latex was determined by measuring the transmission light intensity at 525 nm and 1 cm cuvette using the respective polymer dispersion “as is”, i.e., in its undiluted form, with Photometer DR 6000 (Hach Lange). The light diffusion factor (LD100 value in %) depicts how much of the light is transmitting the sample at a given cuvette length respective to pure water which exhibits a LD100 value of 100.

### 1.7 pH Value

pH values of the synthesized polymer latices were measured at ambient conditions utilizing a Portamess 913 pH-meter (from Knick Elektronische Messgeräte GmbH & Co. KG) equipped with a glass electrode from SI Analytics. The device is calibrated on regular terms with two buffer solutions (pH 7.00/pH 9.21).

### 1.8 Brookfield Viscosity

Viscosity was measured at 20° C. according to the standard method DIN EN ISO 3219:1994 using a “Brookfield RV”-type laboratory viscosimeter employing spindles #4 or #5 at 100 revolutions per minute.

### 1.9 Acid Value (AV)

Acid value (also referred to as neutralization number or acid number or acidity) is the mass of potassium hydroxide (KOH) in milligrams that is required to neutralize one gram of chemical substance. Therefore, the acid value was calculated using the weight percent and molar mass of carboxylic acid monomer (CA) as follows:

$$AV [ \frac{mg KOH}{g polymer} ] = ( \frac{wt . \% ( CA )}{molar mass ( CA ) [ \frac{g}{mol} ]} ) * 561.1 [ mg / mol ]$$

Acid value is given in unit of mg KOH/g polymer. For example, the acid value of 10 wt. % of acrylic acid (AA) is of 78 mg KOH/g polymer the acid value of 10 wt. % of methacrylic acid (MAA) is of 65 mg KOH/g polymer according to the above-described formula according to the above-described formula.

### 1.10 Confocal Laser Scanning Microscopy

To analyze the degree of wood penetration of the stain formulations, acacia wood samples treated with the stain formulations were measured using confocal laser scanning microscopy (CLSM), by analogy with “Enlightened TiO₂-scattering, bound by a better binder”, Boyko et al., european coatings journal 2018 (5), 50-55. The sample CE2 (Acronal A508) was mixed with 1000 ppm sodium fluorescein (hydrophil) and 200 ppm nile red (hydrophob) while the sample CE4 (Joncryl 8085) was mixed with 200 ppm fluorol yellow that is more hydrophob than nile red. The dyed dispersions or solutions were applied to wood sample and dried for several days. Afterwards, a slice was cut from the wood sample by a microtome and was analyzed in reflection, geometry and fluorescence of the individual components. All depicted images are maximum projections from xyz image stacks. In addition, an untreated wood sample was observed with the same settings and conditions to exclude autofluorescence.

The applied imaging parameters are as follows:
excitation wavelength: 488 nm (fluorescein), 561 nm (nile red),
emission wavelength: 500-530 nm (fluorescein), 580-750 nm (nile red),
objective: 50×0.8 DRY,
image sizes: 310×310 μm and 100×100 μm,
scan time/frame: 400 Hz, and
scan mode: xyz.

The following abbreviations are used
AAEM 2-(acetoacetoxy) ethyl methacrylate
DAAM diacetone acrylamide
UMA-25 25 wt % solution of 2-(imidazolin-2-on-1-yl) ethyl methacrylate in methyl methacrylate
IOMPA isooctyl 3-mercaptopropionate
ADDH adipic acid dihydrazide
AA acrylic acid
MA methyl acrylate
CA carboxylic acid
MMA methyl methacrylate
BA n-butyl acrylate
BMA n-butyl methacrylate
MAA methacrylic acid
CHMA cyclohexyl methacrylate
EHA 2-ethlyhexyl acrylate
Tg^{t} (Fox) Theoretical glass transition temperature calculated by the Fox equation
PS Median particle size
S.C. Solids content
CLSM confocal laser scanning microscopy

### Inventive Example 1 (IE1)

The emulsifier 1 used in the following examples is a 25 wt. % aqueous solution of the sodium salt of a sulphated ethoxylated alkyl glyceryl allyl ether of the formula (III), degree of ethoxylation=10 (Adeka Reasoap SR-1025).

A polymerization vessel equipped with metering devices and temperature regulation was charged at +20 to +25° C. (room temperature) under a nitrogen atmosphere with
546.7 g of deionized water and
8.2 g of emulsifier 1.

This initial charge was heated to +80° C. with stirring. When this temperature had been reached, the entire feed 1 was added.

Feed 1 (homogeneous solution of):
9.1 g of deionized water and
1.2 g of ammonium peroxodisulfate

Thereafter feed 2 was commenced and was metered in over the course of 45 minutes.

Feed 2 (homogeneous mixture of):
150.7 g of deionized water
3.3 g of emulsifier 1
204.0 g of a 20 wt. % aqueous solution of DAAM
20.0 g of IOMPA
32.6 g of a 25 wt. % solution of UMA in MMA monomer
120.4 g of n-butyl acrylate
173.4 g of n-butyl methacrylate, and
40.8 g of methacrylic acid

After the end of feed 2, 49.3 g of deionized water was added and polymerization was continued for another 10 minutes, then feed 3 was added and stirred in.

Feed 3:32.
2 g of a 25 wt. % strength ammonia solution

Afterwards, the polymerization mixture was left to react further at +80° C. for 30 minutes; then 62.4 g of deionized water were added and stirring was carried out at +80° C. for another 30 minutes.

20.5 g of solid ADDH were added to the mixture followed by addition of 76.6 g of deionized water; stirring was continued for 30 more minutes.

The aqueous polymer composition obtained by the process described above was then cooled to room temperature. After addition of 34.0 g of 0.5% biocide solution and 60.2 g of additional water, the aqueous polymer composition was filtered through a 125 μm filter.
Particle size (HDC, median): 24 nm
Tg^{t} (Fox): 24° C.
Solids content: 27.4%

### Inventive Examples 2 to 6 (IE2 to IE6)

Further aqueous polymer compositions were prepared in the same way as for inventive example 1 (IE1), with the monomers used and/or the amounts of monomers being varied. The changes in the recipe and the analytic results can be seen from the following table 1. The amounts of monomers are given in weight percent with respect to the total weight of monomers.

### Inventive Example 7 (IE7)

Further aqueous polymer composition was prepared in the same way as for inventive example 1 (IE1) using polyetheramine T-403 (213.2 g of a 10 wt. % aqueous solution of polyetheramine) instead of ADDH as crosslinker. The changes in the recipe and the analytic results can be seen from the following table 1. The amounts of monomers are given in weight percent with respect to the total weight of monomers.

TABLE 1
Monomers used in inventive examples and analytic results of inventive examples IE1 to IE7

| | wt.-% | | | | | | |
|---|---|---|---|---|---|---|---|
| Monomers | IE1 | IE2 | IE3 | IE4 | IE5 | IE6 | IE7 |
| BA | 29.5 | 26.5 | 38.7 | 45.3 | 60.0 | 42.6 | — |
| EHA | — | — | — | — | — | — | 13 |
| BMA | 42.5 | — | — | — | — | — | 49.0 |
| CHMA | — | — | — | — | — | 25.0 | — |
| MMA | — | 45.5 | 33.3 | 26.7 | 12.0 | 4.4 | — |
| MAA | 10.0 | 10.0 | 10.0 | 10.0 | 10.0 | 10.0 | 10.0 |
| UMA-25 | 8.0 | 8.0 | 8.0 | 8.0 | 8.0 | 8.0 | 8.0 |
| DAAM | 10.0 | 10.0 | 10.0 | 10.0 | 10.0 | 10.0 | — |
| AAEM | | — | — | — | — | — | 20 |
| Total | 100 | 100 | 100 | 100 | 100 | 100 | 100 |
| Analytic results | | | | | | | |
| Tg^{t} (Fox) [° C.] | +24 | +58 | +36 | +26 | +5 | +26 | +25 |
| Particle size (PS) [nm] | 24 | 24 | 24 | 24 | 24 | 24 | 30 |
| Molecular weight [g/mol] | 8900 | 9250 | n.d.* | n.d. | n.d. | 13.200 | 9.270 |
| Solids content | 27.4% | 27.3% | 27.1% | 27.2% | 26.9% | 27.1% | 22.8% |
| Degree of neutralization | 100% | 100% | 100% | 100% | 100% | 100% | 100% |
| pH value | 9.1 | 8.4 | 8.8 | 8.8 | 8.9 | 8.8 | 8.8 |
| Brookfield viscosity | 1440 | 612 | 4200 | 1280 | 4640 | 2400 | 16 |
| [mPas] | | | | | | | |

*n.d. stands for “no date”

### Stain Formulation

Moreover, paint formulations comprising inventive examples of IE2 to IE7 and comparative examples of CE1 to CE5 were prepared according to the following procedure and their tackiness, penetration, water resistance (water spot test), wet adhesion and weather resistance (outdoor exposure) were analyzed. The results are summarized in the following table 2.

### A. Stains Formulation with Inventive Examples IE2 to IE7

In an initial step, a paste was prepared by mixing ingredients 1. 3. and 4. homogenizing the mixture with a Speedmixer (Fa. Hauschild) utilizing the following program for dispersing: 30 s at 800 rpm, 30 s at 1000 rpm, 30 s at 1650 rpm, 60 s at 1600 rpm and finally 30 s at 2350 rpm. In parallel, ingredients 2, 5, and 6, were mixed under stirring (binder latex as initial charge with dropwise addition of the other components) and homogenized with help of a Dissolver for 2 min at 1000 rpm. After addition of the afore-mentioned paste to the binder-containing mixture the resultant blend was homogenized for another 5 min at 1000 rpm. The paste was rinsed in a container with deionized water (DI-water, ingredient 7.) and the rinsing water was added to the stain formulation. The ingredients 1, to 13, are summarized in the following table A.

TABLE A
Ingredients 1. to 7.

| # | Compound | Description (supplier) | Amount [g] |
|---|---|---|---|
| 1 | DI-water (1) | | 20 |
| 2 | Hydropalat 3220WE | Wetting agent (BASF) | 1 |
| 3 | Tego Foamex 825 | Defoamer (Evonik) | 2 |
| 4 | Luconyl NG1916 | Pigment paste (BASF) | 4 |
| 5 | Binder / Example | (s.c. 27.0%) | 170 |
| 6 | Laponite SL25 | Thickener (BYK) | 2 |
| 7 | DI-water (2) | | 126 |
| TOTAL | | | 325 |

An overall solids content of ˜15% is targeted as well as a viscosity by Ford flow cup (F2) between 45 and 55 s (ASTM D1200). The amount of Laponite SL25 can therefore vary slightly depending on initial viscosity, and is compensated by adjusting DI-water (2) accordingly.

Other additives like light stabilizers (both UV-absorbers and HALS), antioxidants, pigments, matting agents, hydrophobizing waxes, anti-slip additives etc. can be added for further esthetic and performance improvements.

### B. Stain Formulations with Comparative Examples CE1 to CE5

To obtain stain formulations comprising comparative examples, the same procedure for stain formulations with inventive examples, as described above under the point A, was carried out with the different comparative binders CE1 to CE5 instead of inventive examples IE2 to IE7. The comparative binders CE1 to CE5 are commercially available. For preparing the stain formulation with comparative example CE5 (S-CE5 of the table B) CE5 (Jonres E56) is solved in aqueous ammonia solution (NG 80%) and mixed with ADDH as crosslinking agent in a stoichiometric amount. The binders used in each stain formulation and mechanical properties of the binders are summarized in the following table B.

TABLE B
Summary of stain formulations and mechanical properties
(median particle size (PS)), glass transition temperature
(Tg^{t}), AV) of binders used in the formulations

| | | | Tg^{t} | AV[mg |
|---|---|---|---|---|
| Stain | | PS (median) | (Fox) | KOH/ |
| formulation | Binder | [nm] | [° C.] | g polymer] |
| S-CE1 | CE1 | 87 | −12 / +121 | 10 |
| | (Acronal 6277) | | | |
| S-CE2 | CE2 | 56 | −4 | 19 |
| | (Acronal A508) | | | |
| S-CE3 | CE3 | 37 | −10 / +93 | 22 |
| | (Acronal 6323) | | | |
| S-CE4 | CE4 | dissolved | +57 | 238 |
| | (Joncryl 8085) | | | |
| S-CE5 | CE5 | dissolved | +113 | 78 |
| | (Jonres E56) | | | |
| S-IE2 | IE2 | 24 | +58 | 65 |
| S-IE3 | IE3 | 24 | +36 | 65 |
| S-IE4 | IE4 | 24 | +26 | 65 |
| S-IE5 | IE5 | 24 | +5 | 65 |
| S-IE6 | IE6 | 24 | +26 | 65 |
| S-IE7 | IE7 | 30 | +25 | 65 |

### Stain Evaluation

The stain is applied by dip coating onto acacia wood panels of 5×20×1 cm with rounded edges in the longitudinal direction (along the grain). These dip-coated panels are then dried in vertical position so that excess stain can gravimetrically drip off the wood. After drying for 24 h under ambient conditions the dip coating is repeated followed by another 24 h of drying at room temperature and relative humidity (RH) of 50%.

The following tests are carried: tackiness, penetration, water spot test, wet adhesion and outdoor exposure.

### A. Tackiness

The formation of a coating film is not necessary and mostly undesired in terms of esthetics. Tackiness is evaluated by touching the dried panels and evaluating the haptics. This can also be interpreted as a measure for wood penetration from the sensory experience as it can be assumed that the tackier the surface the less the sample has penetrated into the wood.

Tackiness was rated with a minus sign (−) for bad tackiness, with a plus/minus sign (+/−) for moderate tackiness and with a plus sign (+) for good tackiness.

### B. Penetration

It is desirable to have good penetration of the stain into the wood that also mechanically anchors pigments to the wood surface. The degree of wood penetration has been evaluated in S-CE3 and S-IE6 by using confocal laser scanning microscopy through selective staining of the aqueous and polymeric phases using appropriate dyes (fluorescein for the aqueous phase, nile red for the polymeric phase). This allows the visualization of the penetration of both water and polymer from a cross-cut through the wood. It furthermore gives an indication of the film thickness. The results are given as depth of penetration in μm.

### C. Water Resistance (Water Spot Test)

Water spot testing is carried out by applying 3 mL of DI-water onto the coated panel with a contact time of 6 hours. After this time the water is wiped off by a paper cloth and the spot visually inspected. For some of the polymers in the comparative examples, it could be seen that they had re-dissolved. Thus, it is imported that solubility after application and the relatively short drying times is minimized. In other cases, a dark spot could be observed that wanders along the wood grain underneath the coating and beyond the water contact location. In other cases, there were still slight changes of color and/or changes in the gloss visible. Finally, there were samples that showed no changes.

Water resistance was rated with a minus sign (−) for bad water resistance, with a plus/minus sign (+/−) for moderate water resistance and with a plus sign (+) for good water resistance.

### D. Wet Adhesion

For selected samples, wet adhesion was tested after DIN 53151 using the coated acacia panels.

Wet adhesion was rated with a minus sign (−) for bad wet adhesion, with a plus/minus sign (+/−) for moderate wet adhesion and with a plus sign (+) for good wet adhesion.

### E. Weather Resistance (Outdoor Exposure)

For outdoor exposure testing, the panels are mounted on a rack and placed outside in the open, horizontally. Each stain is applied to 4 different acacia panels of which one is retained inside for comparison. Weathering of the other three is visually inspected in different time intervals with respect to appearance (dirt pick-up, color/gloss changes, cracking and flaking). This test was carried out for 18 months.

Weather resistance was rated with a minus sign (−) for bad weather resistance (cracking and/or flaking), with a plus/minus sign (+/−) for moderate weather resistance (dirty pick-up and/or color/gloss changes) and with a plus sign (+) for good weather resistance (no changes in appearance).

TABLE 2
Evaluation of tackiness, penetration, water resistance,
wet adhesion and outdoor exposure of stain formulations

| Stain | Tacki- | | Water | Wet | Weather |
|---|---|---|---|---|---|
| formulation | ness | Penetration | resistance | adhesion | resistance |
| S-CE1 | − | n.d.* | + | +/− | +/− |
| S-CE2 | +/− | n.d. | − | − | − |
| S-CE3 | +/− | 11 microns | +/− | + | +/− |
| S-CE4 | + | n.d. | − | − | − |
| S-CE5 | + | n.d. | − | +/− | − |
| S-IE2 | + | n.d. | +/− | +/− | − |
| S-IE3 | + | n.d. | +/− | + | + |
| S-IE4 | + | n.d. | + | + | + |
| S-IE5 | + | n.d. | +/− | +/− | +/− |
| S-IE6 | + | 20 microns | + | + | + |
| S-IE7 | + | n.d. | + | + | + |

[−] = bad,
[+/−] = moderate,
[+] = good
*n.d. stands for “no date”

1.-18. (canceled)

19. A method for staining porous materials, the method comprising utilizing a composition comprising an aqueous polymer composition, which contains:
a water-soluble or water dispersible polymer P made of polymerized ethylenically unsaturated monomers M comprising
30 to 90 wt.-%, based on the total weight of monomers M, of at least one monomer M1 selected from C₁-C₁₂-alkyl esters of monoethylenically unsaturated carboxylic acids, C₆-C₁₀-cycloalkyl esters of monoethylenically unsaturated carboxylic acids and monovinylaromatic hydrocarbon monomers,
5 to 30 wt.-%, based on the total weight of monomers M, of at least one monomer M2 selected from monoethylenically unsaturated monomers containing at least one acid group, and
5 to 40 wt.-%, based on the total weight of monomers M, of at least one monomer M3 different from M2 which has a reactive functional group being capable of being crosslinked,
wherein the total weight of monomers M1, M2 and M3 corresponds to at least 90% of the total weight of monomers M;
wherein the monomers M are selected such that the theoretical glass transition temperature according to Fox (Tg^{t}) of the polymer P is at most 80° C.; and
wherein the polymer P is dissolved or dispersed in an aqueous phase such that the acid groups of the polymer P are totally or partially neutralized.

20. The method according to claim 19, wherein the polymer P in the aqueous phase has particle size distribution with mean value of less than 300 nm, as determined at a temperature in the range of 20 to 25° C. by hydrodynamic chromatography fractionation (HDC) of an aqueous polymer dispersion of the polymer P with an aqueous eluent having a pH value in the range of 5.5 to 6.0.

21. The method according to claim 19, wherein the porous materials are wood or wooden materials.

22. The method according to claim 19, wherein the weight-average molecular weight of the polymer P is in the range of 5 to 20 kDa as determined by gel permeation chromatography.

23. The method according to claim 19, wherein the polymer P is obtainable by the polymerization of the monomers M in the presence of at least one chain transfer agent.

24. The method according to claim 19, wherein the amount of monovinylaromatic hydrocarbon monomers does not exceed 25 wt.-%, based on the total weight of monomers M.

25. The method according to claim 19, wherein the monomer M1 comprises at least one monomer M1.a selected from the group consisting of C₁-C₆-alkyl esters of monoethylenically unsaturated monocarboxylic acids and optionally one or more monomers M1.b selected from the group consisting of C₆-C₁₀-cycloalkyl esters of monoethylenically unsaturated monocarboxylic acids and C₇-C₁₀-alkyl esters of monoethylenically unsaturated monocarboxylic acids.

26. The method according to claim 19, wherein the monomer M2 is selected from the group consisting of
monoethylenically unsaturated monocarboxylic acids having 3 to 6 carbon atoms; and
monoethylenically unsaturated dicarboxylic acids having 4 to 6 carbon atoms.

27. The method according to claim 26, where the monomer M2 is methacrylic acid.

28. The method according to claim 19, wherein the reactive functional group of the monomers M3 is selected from the group consisting of urea groups, keto groups, aldehyde groups, epoxy groups and alkoxysilane groups.

29. The method according to claim 28, wherein the reactive functional group of the monomers M3 is selected from the group consisting of monoethylenically unsaturated monomers M3.a) bearing an urea group and monoethylenically unsaturated monomers M3.b) bearing a keto group and combinations thereof.

30. The method according to claim 29, wherein the monomer M3 is selected from the group consisting of
M3.a) C₁-C₄-alkyl esters of acrylic acid and methacrylic acid and the N—C₁-C₄-alkyl amides of acrylic acid and methacrylic acid, wherein the C₁-C₄-alkyl group bears an urea group;
M3.b.1) C₂-C₈-oxoalkyl esters of acrylic acid or methacrylic acid, N—C₂-C₈-oxoalkyl amides of acrylic acid or methacrylic acid,
M3.b.2) C₁-C₄-alkyl esters of acrylic acid or methacrylic acid, and N—C₁-C₄-alkyl amides of acrylic acid or methacrylic acid, wherein the C₁-C₄-alkyl group bears a 2-acetylacetoxy group of the formula O—C(═O)—CH₂—C(═O)—CH₃.

31. The method according to claim 19, wherein the monomers M comprise at least one monoethylenically unsaturated non-ionic monomer M4, which is water soluble.

32. The method according to claim 19, wherein the aqueous polymer composition further comprises a crosslinking agent having at least two functional groups which are capable of forming a covalent bond with the reactive functional group of the polymerized monomer M3.

33. The method according to claim 32, wherein the crosslinking agent is selected from aliphatic dicarboxylic acid dihydrazides and/or polyamines.

34. The method according to claim 33, wherein the monomer M3 is a monomer M3.b.1) and the crosslinking agent is selected from aliphatic dicarboxylic acid dihydrazides or the monomer M3 is a monomer M3.b.2) and the crosslinking agent is selected from polyamines.

35. An aqueous polymer composition, which contains
i) a water-soluble or water dispersible polymer P made of polymerized ethylenically unsaturated monomers M comprising
30 to 90 wt.-%, based on the total weight of monomers M, of at least one monomer M1 selected from C₁-C₁₂-alkyl esters of monoethylenically unsaturated carboxylic acids and C₆-C₁₀-cycloalkyl esters of monoethylenically unsaturated carboxylic acids,
5 to 30 wt.-%, based on the total weight of monomers M, of at least one monomer M2 selected from monoethylenically unsaturated monomers containing at least one acid group, and
5 to 40 wt.-%, based on the total weight of monomers M, of at least one monomer M3 different from M2 which has a reactive functional group being capable of being crosslinked,
wherein the total weight of monomers M1, M2 and M3 corresponds to at least 90% of the total weight of monomers M;
wherein the monomers M are selected such that the theoretical glass transition temperature according to Fox (Tg^{t}) of the polymer P is at most 80° C.; and
wherein the polymer P is dissolved or dispersed in an aqueous phase such that the acid groups of the polymer P are totally or partially neutralized; and
ii) a crosslinking agent having at least two functional groups which are capable of forming a covalent bond with the reactive functional group of the monomer M3,
wherein the polymer P amounts for at least 90% of the total mass of polymers present in the aqueous polymer composition.

36. The aqueous polymer composition of claim 35, wherein the polymer P has particle size distribution with mean value of less than 300 nm, as determined at a temperature in the range of 20 to 25° C. by hydrodynamic chromatography fractionation (HDC).
